(19) United States
(12) Patent Application Publication
(10) Pub. No.: US 2024/0106335 A1
(43) Pub. Date: Mar. 28, 2024

(54) A CONVERTER

(71) Applicant: Auckland UniServices Limited, Auckland (NZ)

(72) Inventors: Duleepa Jayanath THRIMAWITHANA, Auckland (NZ); Wenwei WANG, Auckland (NZ)

(21) Appl. No.: 18/251,479

(22) PCT Filed: Nov. 4, 2021
(86) PCT No.: PCT/IB2021/060192

§ 371 Date: May 2, 2023

(30) Foreign Application Priority Data
Nov. 4, 2020 (NZ) 769619
Dec. 11, 2020 (NZ) 770977

(51) Int. Cl. H02M 3/335; H02J 50/12; H02M 1/08

(52) U.S. Cl. CPC H02M 3/33571; H02J 50/12; H02M 1/083; H02M 3/33515

(57) ABSTRACT

A wireless power transfer system and a method of operating a multilevel converter for wireless power transfer are disclosed. The wireless power transfer system comprises a multilevel converter with stack inductors that both suppress circulating currents and replace the series inductor of a tuned LCL circuit. A zero voltage switching routine for wireless power transfer is also disclosed.

### FIELD OF THE INVENTION

A wireless power transfer system and a method of operating a multilevel converter for wireless power transfer are disclosed herein.

### BACKGROUND

Wireless power transfer can provide a convenient and robust alternative to conventional physical connectors and electrical wiring. Some applications for wireless power transfer include recharging portable consumer devices (such as watches and mobile phones), delivering power to industrial sensors and/or actuators across moving junctions, and charging implanted medical devices across a tissue barrier. Another application, which is used herein as an exemplary embodiment, is charging and power transfer systems for electric vehicles.

Electric vehicles are becoming increasingly popular as a method of sustainable transport. Most existing electric vehicles use wired chargers. Wireless power transfer is expected to offer an attractive alternative in the future. It also has the potential to change the way electric vehicles are charged. For example, some wireless power transfer solutions can facilitate charging when an electric vehicle is park over a designated ground-based charging pad. Most in-home chargers (both wired and wireless) are designed to operate with a single-phase supply and a power rating up to 7.4 kW. This produces charging times in the range of 3-7 hours.

There is increasing demand for fast chargers (both wired and wireless) with power ratings up to 150 kW. These chargers can significantly reduce charging times for some electric vehicles.

For example, the Nissan Leaf can be charged using a 50 kW rapid charger technology to achieve a charging time of 20-30 mins/100 km. The Tesla Model S, on the other hand, can be charged using a 120 kW supercharger technology at a rate of 10 mins/100 km. These developments are expected to make electric vehicles more convenient by producing charging times that are comparable to refueling a vehicle with an internal combustion engine.

There is also burgeoning research into roadway charging. Roadway charging occurs when an electric vehicle is charged while in motion (e.g. on a designated roadways with charging lanes that contain underground charging pads). This application is referred to as in-motion charging or dynamic charging. Roadway charging has the potential to provide a cost-effective solution to some of the challenges that are limiting the adoption of electric vehicles, such as limited range and charging speed. A study conducted by Utah State University has shown that an electric vehicle with a 25 mile on-board electrical range and a 50 kW in-motion charging system can meet 99% of the mobility requirements of a typical light-duty vehicle user.

Wireless power transfer systems can usually be classified as tightly coupled or loosely coupled. The two systems are often not compatible. Loosely coupled systems operate with greater variability when compared to tightly coupled systems. For example, loosely coupled systems have to contend with a wide range of coupling factors (caused by misalignment) because the primary and secondary units are not physically constrained. Load variations tend to have a disproportionate impact on loosely coupled systems because the tuning of the resonant couplers is affected. This creates divergent design objectives that can make the two systems incompatible. Electric vehicle chargers and sophisticated consumer electronics (e.g. mobile phones) tend to employ loosely coupled systems.

### SUMMARY OF INVENTION

A method of operating an inductive powertransfer primary is disclosed. The method comprises switching a multilevel converter to produce a repeating AC waveform across a compensation network of a resonant inductive power transfer primary, wherein the multilevel converter comprises a plurality of submodules each having at least two switches, and the method comprises complementarily switching the at least two switches of each of the plurality of submodules to substantially coincide with zero crossings in the repeating AC waveform.

A method of driving a resonant inductive power transfer primary is disclosed. The method comprises driving a resonant inductive power transfer primary at discrete power levels by operating a multilevel converter at a resonant frequency of the resonant inductive power transfer primary, wherein the multilevel converter comprises a plurality of submodules and each of the plurality of submodules has at least two switches, and the method comprises switching the submodules of the converter with a duty cycle selected from the group of duty cycles consisting of: 0%, 50% and 100%.

A method of switching a multilevel inverter to cause inductive power transfer is disclosed. The method comprises switching the multilevel inverter to cause inductive power transfer from a resonant inductive powertransfer primary, wherein the multilevel inverter comprises a plurality of submodules, and the method comprises switching each of the plurality of submodules, with zero voltage turn-on, to selectively insert each of the plurality of submodules into a circuit with a compensation network of the resonant inductive power transfer primary.

A resonant wireless power transfer device is disclosed. The resonant wireless power transfer device comprises:
a multilevel converter comprising at least two phases, wherein each of the at least two phases comprises an upper stack with at least one submodule and a lower stack with at least one submodule, and
a tuned coil with a compensation network, wherein the compensation network is configured to tune the coil for wireless powertransfer at an operating frequency of the resonant
wireless power transfer device, wherein the tuned coil is connected between the upper stack and the lower stack of the at least two phases of the multilevel converter.

A resonant inductive power transfer primary is disclosed. The resonant inductive power transfer primary comprises a transmitter coil, a series-parallel compensation network for the transmitter coil, and a modular multilevel converter having at least two phases, wherein the series inductance of the series-parallel compensation network comprises at least one inductor from each of the at least two phases of the modular multilevel converter.

A resonant wireless power transfer device is disclosed. The resonant wireless power transfer device comprises a coil, at least one tuning capacitor that tunes the coil for resonance at an operating frequency of the resonant wireless power device, and a multilevel converter connected to the coil and the tuning capacitor, wherein the multilevel converter comprises an upper stack with at least one submodule and a lower stack with at least one submodule, and the coil and the at least one tuning capacitor are connected to the multilevel converter at a point between the upper stack and the lower stack.

### DRAWING DESCRIPTION

A number of embodiments of the invention will now be described by way of example with reference to the drawings as follows.

FIG. 1 is a schematic circuit diagram of an exemplary wireless power transfer system comprising a multilevel converter with a single limb (also referred to as a single phase converter).

FIG. 2 is a schematic circuit diagram of an exemplary wireless power transfer system comprising a multilevel converter with two limbs (also referred to as a two phase converter).

FIGS. 3a-3d are schematic circuit diagrams that depict several steady-state switching patterns for a simplified single limb multilevel converter with two submodules.

FIG. 4 is a schematic representation of an embodiment of the wireless power transfer system shown in FIG. 2.

FIG. 5 is a schematic circuit diagram of an exemplary wireless power transfer system comprising a two phase multilevel converter with integrated magnetics.

FIG. 6 is a schematic representation of the wireless power transfer system shown in FIG. 5 depicting the AC and DC current paths for the two phases of the multilevel converter.

FIG. 7 is a schematic circuit diagram of an exemplary wireless power transfer system comprising a three-phase multilevel converter.

FIGS. 8a-8c are equivalent circuit diagrams for a single phase multilevel converter with coupled stack inductors.

FIGS. 9a-9d are a series of equivalent circuit diagrams for the wireless power transfer system shown in FIG. 5.

FIG. 10 is a diagram showing the phase angle and duty cycle for a unipolar waveform.

FIG. 11a is a series of exemplary voltage waveforms showing medium power phase angle control switching for the converter of FIG. 4.

FIG. 11b is a series of exemplary voltage waveforms showing high power phase angle control switching for the converter of FIG. 4.

FIG. 12a is a series of exemplary voltage waveforms showing medium power duty cycle control switching for the converter of FIG. 4.

FIG. 12b is a series of exemplary voltage waveforms showing high power duty cycle control switching for the converter of FIG. 4.

FIG. 13a shows the voltage and current waveforms produced in the compensation network of an inductive power transfer primary by a soft switched dual stack multilevel converter.

FIG. 13b shows the gate signals, voltage and current waveforms for the MOSFET switches of a soft switched half-bridge submodule.

FIG. 14 is a schematic representation of the switching states for a submodule operating at 0%, 50% and 100% duty cycle.

FIG. 15 is a series of voltage waveforms showing duty cycle control of a dual stack multilevel converter for zero voltage switching and/or soft switching in an inductive power transfer primary.

FIGS. 16a-16c are schematic representations of an inductive power transfer primary with a dual stack inverter operating at three discrete power levels with zero voltage switching and/or soft switching in an inductive power transfer primary.

### DETAILED DESCRIPTION OF THE DRAWINGS

Wireless power transfer systems include inductive power transfer (IPT) systems. Specific examples of wireless power transfer systems, apparatus and methods that include inductive coupling are provided in this disclosure, and these examples are applicable to wireless power transfer apparatus, systems and methods.

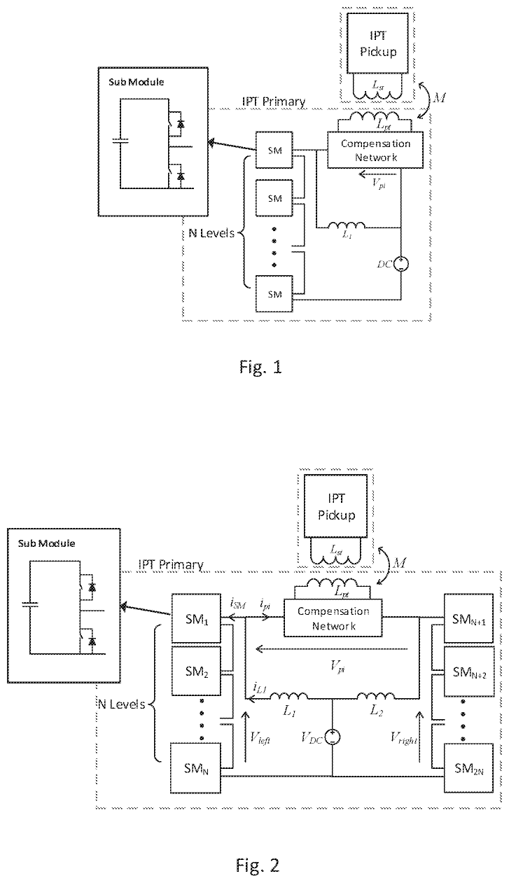

An exemplary wireless power transfer system is shown schematically in FIG. 1. The illustrated system comprises inductive couplers (Lₚₜ and Lₛₜ) that transfer power across a variable air gap between a primary device and a secondary device. The inductive couplers (Lₚₜ and Lₛₜ) are loosely coupled by a mutual inductance (M). In the illustrated embodiment, the primary and secondary couplers (Lₚₜ and Lₛₜ) are tuned to substantially the same operating frequency by respective compensation networks. Each compensation network forms a resonant circuit with the respective magnetic coupler (Lₚₜ and Lₛₜ) to tune the primary and secondary devices for inductive power transfer.

The primary side compensation network shown in FIG. 1 is driven by a multilevel converter. The multilevel converter comprises a stack of series connected submodules (SM). Each of the illustrated submodules (SM) comprises a half-bridge connected capacitor. The converter can use other switching cell topologies in place of the half-bridge cells shown in FIG. 1. For example, the submodules (SM) can incorporate full bridge switching cells, cascaded half-bridge switching cells, and/or neutral-point clamped switching cells. The switching cells are configured to switch the submodule capacitors into—and out of—a circuit with the compensation network. The converter manipulates the switching state of the submodules (SM) to control the power transferred between the primary side and the secondary side of the wireless power transfer system and regulate the charge stored in the submodule (SM) capacitors.

The illustrated converter is configured to operate the half-bridge switching cell of each submodule to insert or bypass the submodule capacitor. The high-side switch of each submodule (SM) couples the capacitor with the compensation network when in a conducting state. The low-side switch of each submodule (SM) functions to bypass the capacitor when in a conducting state. The multilevel converter is configured to operate the switches of the switching cell with a complementary switching pattern so that only one switch conducts at a time. In at least some embodiments, the switching pattern includes a non-overlapping dead time (a delay between turn-off and turn-on where neither switch is conducting).

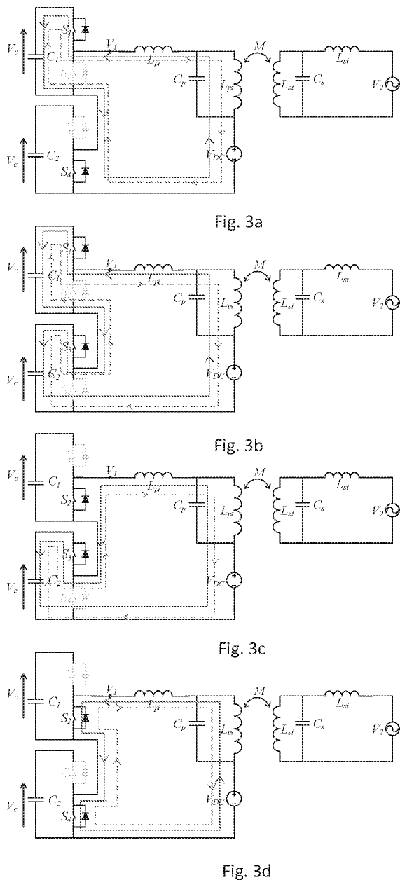

The submodules (SM) are connected to a DC power source through a DC inductor (L₁). The multilevel converter is configured to use the DC inductor (L₁) to boost the voltage across the submodules capacitors when they are inserted into a circuit with the compensation network. In at least some embodiments, the converter operates the DC inductor (L₁), submodule capacitors and the DC power source to replicate the functionality of a conventional boost converter. For example, the converter switching configuration shown in FIG. 3d stores energy from the DC power source in the magnetic field of the DC inductor (L₁). The converter can subsequently transfer the stored energy in the submodule (SM) capacitors (e.g. the upper submodule (SM) in the switching configuration shown in FIG. 3a) by boosting the voltage across the capacitors when they are switched into the circuit.

Another exemplary wireless power transfer system is shown schematically in FIG. 2. The system of FIG. 2 is depicted with the same building blocks as the system shown in FIG. 1, and the two systems operate in fundamentally the same way to transfer power across a variable air gap between loosely coupled coils (Lₚₜ and Lₛₜ). However, the primary side of the system shown in FIG. 2 comprises a multilevel converter with the submodules (SM) divided into two limbs (also referred to as a two phase multilevel converter). Each limb or phase comprises a stack of series connected half-bridge submodules (SM). The converter can use other switching cell topologies in place of the half-bridge cells shown in FIG. 1. For example, the submodules (SM) can incorporate full bridge switching cells, cascaded half-bridge switching cells, and/or neutral-point clamped switching cells.

The primary side compensation network is connected across the limbs of the converter. In this configuration, the converter can alternately switch submodules (SM) from the two limbs to produce a symmetric bipolar voltage waveform at the resonant frequency of the compensation network. The amplitude of the voltage waveform across the compensation network can be regulated to control the power transferred to the secondary side.

Each limb of the converter is connected to a DC power source through a DC inductor (L₁ and L₂). In at least some embodiments, the submodules (SM) are configured to extract energy from the DC power source 400 without other circuitry. In the illustrated embodiment, the converter is configured to replicate the function of a conventional boost converter with the submodule capacitors and DC inductors (L₁ and L₂). This enables the multilevel converter to generate an AC voltage waveform with an amplitude that exceeds the voltage of the DC power source 400. The converter applies the AC voltage waveform across the compensation network in the illustrated embodiment. Under steady-state conditions, the average voltage across each of the DC inductors (L₁ and L₂) is zero (based on to the volt-second rule). This leads to a voltage balance between the converter limbs (i.e. V_{left}=V_{right}=V_{DC}) and zero DC offset across the compensation network (Vₚᵢ).

The switching states for an embodiment of the resonant inductive power transfer system of FIG. 1 is shown schematically in FIGS. 3a-3d. The system is assembled around tuned LCL circuits on the primary and secondary sides that are tuned to a common operating frequency. The primary LCL circuit comprises a series-parallel compensation network (comprising a series inductor (Lₚᵢ) and a parallel capacitor (Cₚₜ) in the illustrated embodiment) connected to the primary coil (Lₚₜ). The secondary LCL circuit comprises a series-parallel compensation network (comprising a series inductor (Lₛᵢ) and a parallel capacitor (Cₛₜ) in the illustrated embodiment) connected to the secondary coil (Lₛₜ). The secondary load is represented by a voltage power source.

The primary LCL circuit is driven by a multilevel converter with two series connected half-bridge submodules. The converter has four switching states (shown in FIGS. 3a-3d). The switching states are alternated to control the power transferred to the secondary and regulate the charge stored in the submodule (SM) capacitors. The series inductor (Lₚᵢ) and the magnetic coupler (Lₚₜ) of the LCL circuit replace the DC inductor (L₁) shown in FIG. 1. In this embodiment, the converter uses the compensation network inductors (Lₚᵢ and Lₚₜ) to facilitate the transfer of energy, from the DC power source to the submodule capacitors, by boosting the voltage across the submodules. The illustrated inductors (Lₚᵢ and Lₚₜ) boost the DC voltage across the submodules in addition to tuning the primary side magnetic coupler for resonant inductive power transfer.

In the steady-state switching patterns shown in FIGS. 3a-3d, DC current flows from the DC power source into the submodules, charging the submodule capacitors and transferring energy from the DC power source to the submodules. An AC current flows through the LCL network, driving the primary coil (Lₚₜ) and transferring power to the secondary via the magnetic couplers (Lₚₜ and Lₛₜ). The solid (red) line shown in FIGS. 3a-3c represents DC current path. The dashed (blue) line represents AC current path.

In FIG. 3a, the converter switches the high-side switch (S₁) of the upper submodule and the low-side switch (S₄) of the lower submodule into a conducting state. This inserts the upper submodule into a circuit with the compensation network (the LCL circuit) and bypasses the lower submodule. When the converter is operating at steady-state, the LCL circuit inductors (Lₚᵢ and Lₚₜ) and submodule capacitor (C₁) operate as a boost converter. The series inductor (Lₚᵢ) and the magnetic coupler (Lₚₜ) boost the voltage across the upper submodule. This causes DC current to flow into the submodule and charge the capacitor (C₁). Under steady-state operating conditions, the average voltage across the capacitor (C₁) is equal to the voltage of the DC power source (V_{dc}) and the voltage across the LCL circuit is equal to 0V.

In FIG. 3b, the converter switches the high-side switch (S₁) of the upper submodule and the high-side switch (S₃) of the lower submodule into a conducting state. This inserts the upper submodule and the lower submodule into a circuit with the compensation network (the LCL circuit). The LCL circuit inductors (Lₚᵢ and Lₚₜ) and submodule capacitors (C₁ and C₂) operate as a boost converter. DC current to flows into the submodules and charges the capacitors (C₁ and C₂). In this configuration, the voltage at V₁ is +2V_{dc} and the voltage across the LCL circuit is equal (in magnitude) to the voltage of the DC power source (+V_{dc}). In this configuration, energy is transferred from the capacitors to the secondary side via the magnetic couplers (Lₚₜ and Lₛₜ).

The switching state depicted in FIG. 3c is the complement of state shown in FIG. 3a. The converter switches the low-side switch (S₂) of the upper submodule and the high-side switch (S₃) of the lower submodule into a conducting state. This inserts the lower submodule into a circuit with the compensation network (the LCL circuit) and bypasses the upper submodule. The LCL circuit inductors (Lₚᵢ and Lₚₜ and submodule capacitor (C₂) operate as a boost converter. The series inductor (Lₚᵢ) and the magnetic coupler (Lₚₜ) boost the voltage across the lower submodule. This causes DC current to flow into the submodule and charge the capacitor (C₂). Under steady-state operating conditions, the average voltage across the capacitor (C₂) is equal to the voltage of the DC power source (V_{dc}) and the voltage across the LCL circuit is equal to 0V.

FIG. 3d shows a switching state where both submodules are bypassed. The converter switches the low-side switch (S₂) of the upper submodule and the low-side switch (S₄) of the lower submodule into a conducting state. This increases the current through series inductor (Lₚᵢ) and the magnetic coupler (Lₚₜ) of the LCL circuit. Energy from the DC power source is stored in the magnetic field of the inductors (Lₚᵢ and Lₚₜ) in this state and the voltage across the compensation network is −V_{dc}.

The converter is configured to produce an AC voltage waveform across the compensation network by alternating between the switching states shown in FIGS. 3a-3d. For example, the converter can produce a bipolar waveform, with RMS amplitude equal to V_{dc}, by alternating between the switching state shown in FIG. 3b and the switching state shown in FIG. 3d. The converter can also modulate the duty cycle of the voltage waveform across the compensation network by operating in switching states that produce no net voltage across the compensation network for part of the switching period. For example, the converter can produce a waveform with a 25% duty cycle by splitting the first half of the switching period equally between the switching states shown in FIGS. 3b and 3a; and splitting the second half of the switching period equally between the switching states shown in the FIGS. 3d and 3c.

The converter is configured to operate with a switching frequency that avoids any appreciable discharge from the capacitors during a single switching period at steady-state. In at least some embodiments, the converter is configured to balance the voltage of the submodule capacitors so that each submodule operates at or near a nominal voltage. The converter can control the switching state of each submodule (SM) to regulate the time that the submodule capacitor is connected to the DC power source. In some embodiments, the converter has a controller that monitors the voltage of the submodule capacitors and selects converter switching states that maintain an adequate voltage balance. For example, the converter shown in FIGS. 3a-3d can interchange the switching states shown in FIGS. 3a and 3c to balance capacitor voltages without impacting the operation of the converter. The switching states shown in FIGS. 3a and 3c can be interchanged because they produce the same voltage across the compensation network.

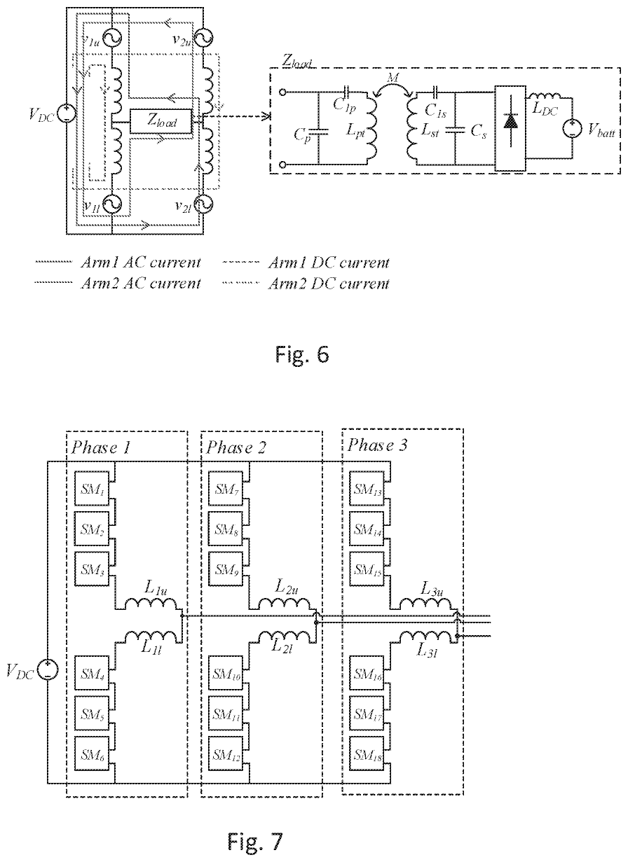

The switching states shown in FIGS. 3a-3d demonstrate how the converter can control the power transferred to the secondary by manipulating the voltage waveform across the compensation network. In at least some embodiments, more submodules can be added to the converter to improve modulation and/or control of the AC voltage waveform using the same fundamental switching principles. For example, staggering the switching phase of multiple submodules (i.e. offsetting the output voltage from the submodules) can be employed to produce a staircase AC waveform across the compensation network. An example is shown in FIGS. 6a and 6b for a dual limb multilevel converter.

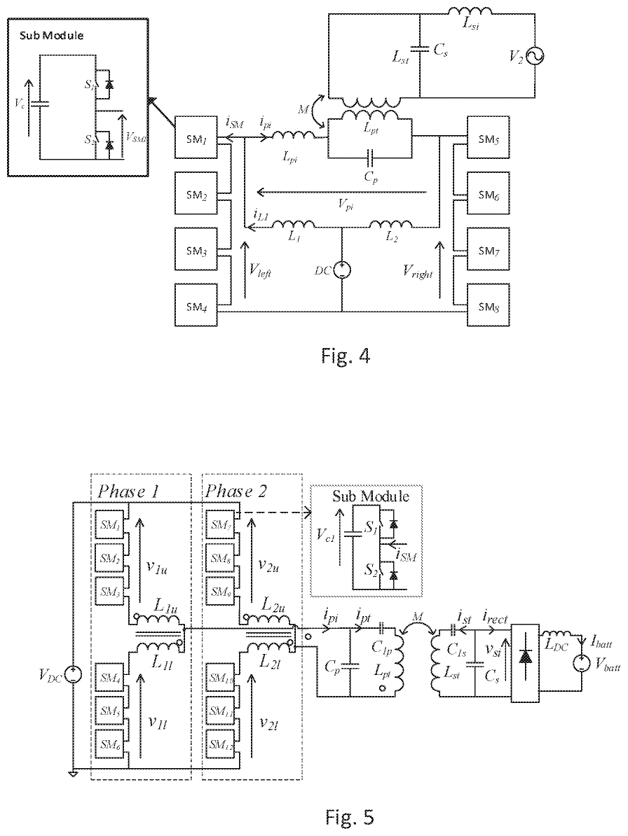

An embodiment of the resonant inductive power transfer system of FIG. 2 is shown schematically in FIG. 4. The system is assembled around LCL networks on the primary and secondary sides that are tuned to a common operating frequency. The primary LCL circuit comprises a series inductor (Lₚᵢ), a parallel capacitor (Cₚₜ), and the primary magnetic coupler (Lₚₜ). The secondary LCL circuit comprises a series inductor (Lₛᵢ), a parallel capacitor (Cₛₜ), and the secondary magnetic coupler (Lₛₜ). The secondary load is represented by a voltage power source.

The primary LCL circuit is connected across the limbs of a multilevel converter. Each limb comprises a stack of four series connected half-bridge submodules (SM). The limbs are connected to a DC power source through respective DC inductors (L₁ and L₂). The converter is configured to switch submodules (SM) from each limb into—and out of—a circuit with the DC power source to produce an AC voltage waveform across the compensation network. In at least some embodiments, a controller (not shown in FIG. 4) maintains the voltage of the submodule capacitors at or near a nominal voltage (for the switching state of the converter) by selecting converter switching patterns responsive to the charge state of each capacitor. For example, the controller can switch the submodules to preferentially discharge overcharged capacitors (i.e. when the capacitor voltage exceeds the nominal voltage for the converter) and/or preferentially charge undercharged capacitors (i.e. when the capacitor voltage is below the nominal voltage).

Another exemplary wireless power transfer system is shown schematically in FIG. 5. In the illustrated embodiment, the stack inductors (L₁ᵤ, L₁ₗ, L₂ᵤ, and L₂ₗ) of the primary side converter are configured to perform the function of the DC inductors (L₁ and L₂) and the series compensation inductor (Lₚᵢ) of the wireless power transfer system shown in FIG. 4. The wireless power transfer system shown in FIG. 5 comprises dissimilar primary and secondary compensation networks. The primary side compensation network comprises an LCL circuit. The secondary side compensation network comprises a parallel tuned or LC circuit. It is possible, and in at least some instances can be preferable, that the primary and secondary side have matched compensation networks (i.e. in some embodiments the primary and secondary compensation networks both comprises LCL circuits).

The multilevel converter depicted in FIG. 5 comprises two limbs (denoted “Phase 1” and “Phase 2”) that are connected across a DC source. Each limb comprises two submodule stacks (an upper stack v₁ᵤ, v₂ᵤ and a lower stack v₁ₗ, v₂ₗ). The upper (v₁ᵤ, v₂ᵤ) and lower (v₁ₗ, v₂ₗ) stacks of each limb are connected through stack inductors (L₁ᵤ, L₁ₗ, and L₂ᵤ, L₂ₗ). The stack inductors of each limb (L₁ᵤ, L₁ₗ, and L₂ᵤ, L₂ₗ) are magnetically coupled and share the same magnetic core in the illustrated embodiment. However, in at least some embodiments, the stack inductors are decoupled and have independent inductor cores. For example, the stack inductors of the three-phase multilevel converter depicted in FIG. 7 have separate magnetic cores and are not magnetically coupled (or are at least not intentionally magnetically coupled) with the other stack inductor of the respective limb.

In at least some embodiments, the stack inductors (L₁ᵤ, L₁ₗ, L₂ᵤ, and L₂ₗ) are configured with substantially the same inductance (i.e. the design specified inductance of each stack inductor is the same, and/or the inductance of each stack inductor is within an acceptable tolerance of a design specified inductance for an applicable industry and/or application). But it is possible, and in at least some instances can be preferable, to configure the inductors with substantially different inductances (i.e. the design specified inductance of each stack inductor is different). The primary compensation network is connected across the two limbs (Phase 1 and Phase 2) at a midpoint between the upper and lower stacks. In the illustrated embodiment, the primary compensation network has a first connection node between the upper stack inductor (L₁ᵤ) and the lower stack inductor (L₁ₗ) of the first limb (Phase 1), and a second connection node between the upper stack inductor (L₂ᵤ) and the lower stack inductor (L₂ₗ) of the second limb (Phase 2)

Current paths for the wireless power transfer system of FIG. 5 are shown schematically in the equivalent circuit of FIG. 6. The primary compensation network (excluding the equivalent series inductance provided by the stack inductors L₁ᵤ, L₁ₗ, L₂ᵤ, and L₂ₗ), the primary coupler, and the loosely coupled secondary device are represented by an equivalent impedance (Z_{load}). Similarly, the four submodules stacks are represented by equivalent AC voltage sources (v₁ᵤ, v₂ᵤ, v₁ₗ, v₂ₗ). The AC current path, generated by the submodules of the multilevel converter, is depicted with solid lines. It passes through the compensation network between the respective limbs of the converter. The DC current path, extending from the DC source through each limb of the converter, is depicted with dashed lines.

In the embodiment illustrated in FIG. 6, a controller switches the two phases/limbs of the converter with a complementary switching pattern. The controller alternates the switching state of the two submodule stacks within each limb during the switching cycle to produce an alternating waveform across the primary compensation network. For example, during the first half of the switching cycle the controller concurrently switches submodules from the upper stack (v₁ᵤ) of the first limb (Phase 1) and submodules from the lower stack (v₂ₗ) of the second limb (Phase 2) into a circuit with the primary compensation network—while submodules from the lower stack (v₁ₗ) of the first limb (Phase 1) and submodules from the upper stack (v₂ᵤ) of the second limb (Phase 2) are switched to a bypassed state. The controller reverses the switching states of the submodules during the second half of the switching cycle. That is, the controller concurrently switches submodules from the lower stack (v₁ₗ) of the first limb (Phase 1) and submodules from the upper stack (v₂ᵤ) from the second limb (Phase 2) into a circuit with the primary compensation network during the second half cycle—while submodules from the upper stack (v₁ᵤ) of the first limb (Phase 1) and submodules from the lower stack (v₂ₗ) of the second limb (Phase 2) are switched to a bypassed state.

The controller can regulate the voltage across the primary compensation network by manipulating the state of individual submodules within the submodule stacks during the switching cycle. For example, the controller can adjust the number of submodules from each stack that are switched into/out of a circuit with the primary compensation network to control the voltage applied to the primary compensation network. In at least some embodiments, the controller maintains a subset of the submodules in the same state (e.g. switched into/out of a circuit a with the primary compensation network) throughout the switching cycle to modulate the voltage applied to the primary compensation network. The switching control presented in FIG. 6 can be extended to polyphase systems, such as the three-phase converter shown in FIG. 7.

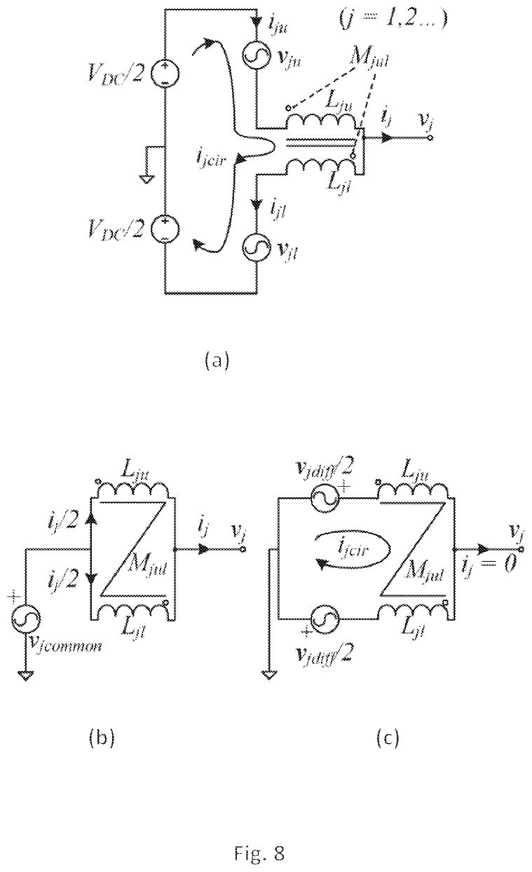

An equivalent circuit for a single phase (j) of the multilevel converter shown in FIG. 5 is presented in FIG. 8a. The DC voltage source (V_{DC}) is divided into two parts (represented by equivalent DC voltage sources V_{DC/2}) that are separated at the mid-point by a virtual ground reference. The submodule stacks are replaced with equivalent AC voltage sources (vⱼᵤ and vⱼₗ) that represent the cascaded voltage from the series connected submodules of each stack. The AC voltages sources (vⱼᵤ and vⱼₗ) are connected through coupled stack inductors (Lⱼᵤ and Lⱼₗ).

The upper (iⱼᵤ) and lower (iⱼₗ) phase currents for the equivalent circuit of FIG. 8a can be expressed by Equations 1 and 2 respectively:

$${i}_{j u} = {i}_{jcir} + \frac{{i}_{j}}{2} \qquad Equation 1$$

$${i}_{j} = {i}_{j c i r} - \frac{{i}_{j}}{2} \qquad Equation 2$$

Where:
   iⱼ=load current;
   iⱼᵤ=upper submodule stack current;
   iⱼₗ=lower submodule stack current;
   i_{cir}=circulating current.

In at least some embodiments, operation of the multilevel converter can be characterised using a common mode equivalent circuit and/or a differential mode equivalent circuit. For example, a common mode equivalent circuit can be used to evaluate the load current (iⱼ). And, in at least some embodiments, a differential mode equivalent circuit can be used to evaluate the circulating current (i_{jcirc}).

A common mode equivalent circuit for a single phase of the multilevel converter of FIG. 5 is presented in FIG. 8b. The voltage of the common mode equivalent circuit can be expressed by Equations 3:

$${v}_{common} = \frac{{v}_{ju} - {v}_{jl}}{2} \qquad Equation 3$$

Where:
   V_{common}=common mode voltage;
   vⱼᵤ=upper submodule stack voltage;
   vⱼₗ=lower submodule stack voltage;

A differential mode equivalent circuit for a single phase of the multilevel converter of FIG. 5 is presented in FIG. 8c. The voltages of the differential mode equivalent circuit can be expressed by Equation 4:

v_{diff}=V_{DC}−(vⱼᵤ+vⱼₗ) Equation 4
Where:
   V_{diff}=differential mode voltage;
   vⱼᵤ=upper submodule stack voltage;
   vⱼₗ=lower submodule stack voltage;
   v_{DC}=DC source voltage.

In this example, the circulating current (i_{jcirc}) can be separated into a DC part and an AC part. The DC part of the circulating current (i_{jcirc}) is equivalent to the DC source current shared by the phases of the converter. For the converter shown in FIG. 5, the DC current is split between two phases (Phase 1 and Phase 2). The AC part of the circulating current (i_{jcirc}) is generated by an imbalance of the phase voltages (i.e. the voltage difference (v_{diff}) between each phase of the converter). The DC and AC parts of the circulating current for the converter shown in FIG. 5 can be expressed by Equations 5 and 6 respectively:

$${i}_{jcir} = \frac{{i}_{DC}}{2} + {i}_{jcirAC} \qquad Equation 5$$

$${i}_{jcirAC} = \frac{1}{{L}_{ju} {L}_{jl} + 2 {M}_{jul}} \int {v}_{jdiff} dt \qquad Equation 6$$

Where:
   i_{jcir}=circulating current;
   i_{DC}=DC source current;
   i_{jcirAC}=AC component of circulating current;
   Lⱼᵤ=inductance of the upper stack inductor;
   Lⱼₗ=inductance of the lower stack inductor;
   Mⱼᵤₗ=mutual coupling between the upper and lower stack inductors;
   V_{diff}=differential mode voltage.

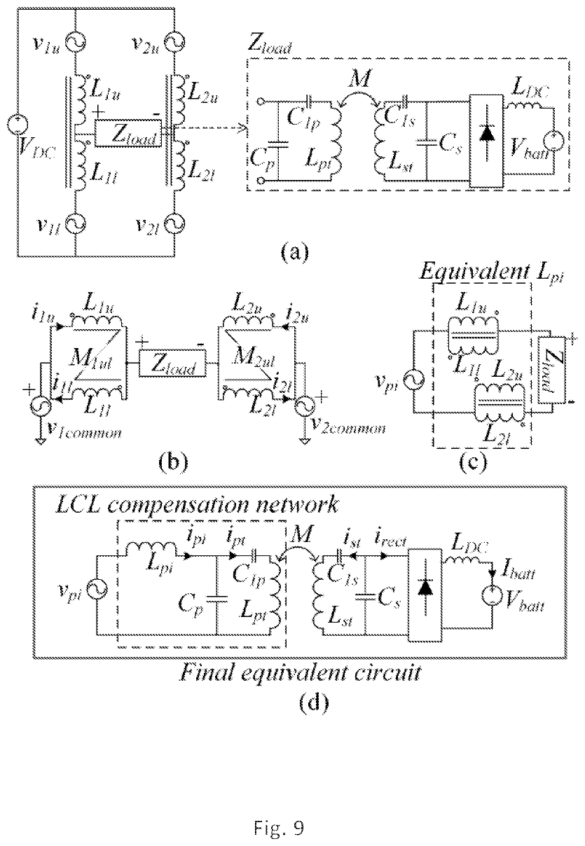

A series of equivalent circuits for the two phase multilevel converter of FIG. 5 are presented in FIGS. 9a-9d.

FIG. 9a depicts a simplified representation of the converter (similar to the equivalent circuit presented in FIG. 6). The primary compensation network (excluding the equivalent series inductance provided by the stack inductors L₁ᵤ, L₁ₗ, L₂ᵤ, and L₂ₗ), primary coupler, and loosely coupled secondary are replaced with an equivalent impedance (Z_{load}). Similarly, the four submodules stacks are replaced by equivalent AC voltage sources (v₁ᵤ, v₂ᵤ, v₁ₗ, v₂ₗ).

FIG. 9b depicts a common mode equivalent circuit that is derived from FIG. 9a using superposition and the voltage source transformation shown in FIG. 8b (i.e. substituting j=1, 2 into equation 3).

FIG. 9c depicts a differential mode circuit that is derived from FIG. 9a using the inductor transformation shown in FIG. 8c.

FIG. 9d depicts a voltage source driven inductive power transfer system that is derived from FIG. 9c with the coupled inductor pairs represented by an equivalent series inductance (Lₚᵢ), and the equivalent load (Z_{load}) expanded to its constituent components. The equivalent voltage source (vₚᵢ) and the equivalent series inductance (Lₚᵢ) shown in FIG. 9d can be expressed by Equations 7 and 8 respectively:

$${v}_{pi} = {v}_{1 common} - {v}_{2 common} = \frac{{v}_{1 u} ( {L}_{1 l} - {M}_{1 ul} ) - {v}_{1 l} ( {L}_{1 u} - {M}_{1 ul} )}{{L}_{1 u} - {L}_{1 l} - 2 {M}_{1 ul}} - \frac{{v}_{2 u} ( {L}_{2 l} - {M}_{2 ul} ) - {v}_{2 l} ( {L}_{2 u} - {M}_{2 ul} )}{{L}_{2 u} - {L}_{2 l} - 2 {M}_{2 ul}} \qquad Equation 7$$

$${L}_{pi} = \frac{{L}_{1 u} {L}_{1 l} - {M}_{1 ul}^{2}}{{L}_{1 u} {+}_{1 l} + 2 {M}_{1 ul}} + \frac{{L}_{2 u} {L}_{2 l} - {M}_{2 ul}^{2}}{{L}_{2 u} {+}_{2 l} + 2 {M}_{2 ul}} \qquad Equation 6$$

Where:
   vₚᵢ=voltage across the primary compensation network;
   v_{1common}=common mode voltage of the first phase;
   v_{2common}=common mode voltage of the second phase;
   v₁ᵤ=phase one upper stack voltage;
   v₁ₗ=phase one lower stack voltage;
   v₂ᵤ=phase two upper stack voltage;
   v₂ₗ=phase two lower stack voltage;
   Lₚᵢ=series inductance of the primary compensation network;
   L₁ᵤ=phase one upper stack inductor;
   L₁ₗ=phase one lower stack inductor;
   L₂ᵤ=phase two upper stack inductor;
   L₂ₗ=phase two lower stack inductor;
   M₁ᵤₗ=mutual inductance between the coupled inductors of the first phase;
   M₂ᵤₗ=mutual inductance between the coupled inductors of the second phase.

The expression for the voltage across the primary compensation network (given in Equation 7) can be simplified when the stack inductors (L₁ᵤ, L₁ₗ, L₂ᵤ, and L₂ₗ) are configured with substantially the same inductance (i.e. the design specified inductance of each stack inductor is the same, and/or the inductance of each stack inductor is within an acceptable tolerance of a design specified inductance for an applicable industry and/or application) and the mutual inductance between the respective coupled inductors (M₁ᵤₗ and M₂ᵤₗ) is substantially the same. The simplified expression is given in Equation 9:

$${v}_{pi} = \frac{( {v}_{1 u} - {v}_{1 l} ) - ( {v}_{2 u} - {v}_{2 l} )}{2} \qquad Equation 9$$

Where:
   vₚᵢ=voltage across the primary compensation network;
   v₁ᵤ=phase one upper stack voltage;
   v₁ₗ=phase one lower stack voltage;
   v₂ᵤ=phase two upper stack voltage;
   v₂ₗ=phase two lower stack voltage;

In the common mode equivalent circuit (FIG. 9b), the stack inductors (L₁ᵤ, L₁ₗ, L₂ᵤ, and L₂ₗ) function as an equivalent series inductor (Lₚᵢ) for the primary compensation network. For example, the stack inductors can be configured to augment or replace the series inductor of an LCL circuit that tunes the primary coil at the operating frequency of the system. The equivalent series inductance (Lₚᵢ) for a two phase converter, such as the converter shown in FIG. 5, can be calculated from Equation 8.

In the differential mode equivalent circuit (FIG. 9c), the stack inductors (L₁ᵤ, L₁ₗ, L₂ᵤ, and L₂ₗ) function as an equivalent DC inductor for each phase of the converter. The equivalent DC inductor (L_{jDC}) stores energy from the DC voltage source (V_{DC}) and transfers it to the submodule capacitors. It can also suppress circulating AC currents (evident from equation 6). The inductance of the equivalent DC stack inductors is given in Equation 10:

L_{jDC}=Lⱼᵤ+Lⱼₗ+2Mⱼᵤₗ Equation 10
Where:
   L_{jDC}=inductance of the equivalent DC inductor for the j^{th} phase;
   Lⱼᵤ=inductance upper stack inductor of the j^{th} phase;
   Lⱼₗ=inductance of the lower stack inductor of the j^{th} phase;
   Mⱼᵤₗ=mutual inductance between the coupled stack inductors for the j^{th} phase.

At lower operating frequencies, where the submodules are switched at tens or hundreds of hertz (e.g. 10 Hz-500 Hz), the converter can be configured to suppress the AC circulating currents (i_{jcirAC}) by controlling and/or regulating the differential mode voltage (V_{diff}). At higher operating frequencies (e.g. in the kHz range and above), the stack inductors (L₁ᵤ, L₁ₗ, L₂ᵤ, and L₂ₗ) can be configured to present sufficiently high impedance (L_{jDC}) to limit the AC circulating current without active control. Resonant wireless power transfer systems typically operate in the kHz to GHz range. For example, the automotive-engineering organization SAE International has settled on 85 kHz (81.39 kHz-90.00 kHz) for electric vehicle chargers. The Wireless Power Consortium has adopted operating frequencies in the range of 87-205 kHz for their standards.

In at least some embodiments, the stack inductors (L₁ᵤ, L₁ₗ, L₂ᵤ, and L₂ₗ) are configured to replace the series inductor (Lₚᵢ) of an LCL circuit, and function as an equivalent DC inductor (L_{jDC}) for the stacks of the converter. For example, the stack inductors (L₁ᵤ, L₁ₗ, L₂ᵤ, and L₂ₗ) can be configured to give an equivalent series inductance (Lₚᵢ) that is substantially the same as the inductance of the primary coupler (Lₚₜ), and an equivalent DC inductance (L_{jDC}) that is sufficiently large to store energy from the DC voltage source (V_{DC}) and suppress circulating currents. In at least some embodiments, the converter is not sensitive to, or at least less sensitive to, the inductance of the equivalent DC inductor (L_{jDC}), so long as it is sufficiently large to store energy from the DC voltage source (V_{DC}) and suppress circulating currents. For example, a wide range of stack inductances can provide satisfactory equivalent DC inductance (L_{jDC}) in at least some wireless power applications, which can permit precise specification of the equivalent series inductance (Lₚᵢ) based on the tuning requirements of the primary compensation network (i.e. the loose constraints for the equivalent DC inductor (L_{jDC}) do not inhibit tuning of the LCL circuit). For example, in at least some wireless power transfer applications, the converter can be configured with an equivalent series inductor (Lₚᵢ) that is within 10% of the ideal inductance for tuning at the specified operating frequency. In some embodiments, the converter can be configured with an equivalent series inductance (Lₚᵢ) that is within 0-3% of the ideal inductance.

The multilevel converter shown in FIGS. 5 to 9 can form part of a resonant wireless power transfer device. For example, a resonant inductive powertransfer primary is depicted in FIG. 5. The resonant inductive power transfer primary comprises a transmitter coil, a series-parallel compensation network for the transmitter coil, and a modular multilevel converter with two phases. In the illustrated embodiment, the series inductance of the series-parallel compensation network comprises at least one inductor from each of the two phases of the modular multilevel converter. A three phase embodiment of the system is depicted in FIG. 7 without the compensation network and transmitter coil.

In at least some embodiments, the transmitter coil and the series-parallel compensation network comprise a tuned LCL circuit, and the at least one inductor from each of the at least two phases connect the submodules of the modular multilevel converter to the transmitter coil without any intervening inductors. An equivalent series inductance of the at least one inductor from each of the at least two phases can be substantially matched to the combined inductance of the transmitter coil and any tuning capacitance connected in series with the transmitter coil.

For example, an equivalent inductance of the at least one inductor from each of the at least two phases can be substantially the same as the capacitance of the parallel branch of the series-parallel compensation network.

The modular multilevel converter can be configured to produce an AC voltage waveform across the transmitter coil at the resonant frequency of the resonant inductive power transfer primary. In at least some embodiments, the compensation network and the transmitter coil are connected between the phases of the modular multilevel converter, and the converter is configured so there is no DC current path through the transmitter coil.

In at least some embodiments, the converter is configured with at least two phases, each with an upper stack having at least one submodule and a lower stack having at least one submodule. In some embodiments, the resonant wireless power transfer device comprises a tuned coil with a compensation network. The compensation network is configured to tune the coil for wireless powertransfer at an operating frequency of the resonant wireless power transfer device. The tuned coil can be connected between the upper stack and the lower stack of the at least two phases of the multilevel converter. In at least some embodiments, the at least one submodule of the upper stack of each of the at least two phases is connected to the at least one submodule of the lower stack of the respective phase by a stack inductor. The stack inductor of each of the at least two phases can be arranged in series with the tuned coil, and the equivalent series inductance of the stack inductors of the at least two phases can be matched to the inductance of the tuned coil.

The compensation network of the resonant wireless power transfer device often comprises a capacitive branch that is arranged in parallel with the tuned coil. In at least some embodiments, the capacitive branch of the compensation network, the tuned coil and the stack inductor(s) of the multilevel converter can combine in an LCL circuit. For example, the multilevel converter can comprise an inductive branch that connects in series with the coil and has substantially the same inductance as the combined inductance of the coil and any tuning capacitance connected in series with the coil. In some embodiments, the compensation circuit comprises a capacitor arranged in series with the coil that blocks DC current in the compensation network. In general, the inductive reactance of the inductive branch of the multilevel converter is substantially equivalent to the capacitive reactance of the capacitive branch of the compensation network at the operating frequency of the wireless power transfer device.

In at least some embodiments, the at least two phases of the multilevel converter comprise a plurality of submodules. A first subset of the plurality of submodules of each of the at least two phases can be arranged in an upper stack of the respective phase, and a second subset of the plurality of submodules of each of the at least two phases can be arranged in a lower stack of the respective phase. The first subset of the plurality of submodules of each of the at least two phases can be connected to the second subset of the plurality of submodules of each of the at least two phases by at least one DC inductor. The multilevel converter can be configured to sit between the tuned coil and a DC source, and to prevent DC current flowing through the tuned coil.

In at least some embodiments, the at least one submodule of the upper stack and the at least one submodule of the lower stack of each of the at least two phases are connected through at least one stack inductor, and the tuned coil is connected to each of the at least two phases via the at least one stack inductor. The tuned coil and the compensation network can comprise a parallel tuned resonant circuit, and the stack inductors of the multilevel converter can be arranged in series with the parallel tuned resonant circuit to form an LCL tuned network at the operating frequency of the wireless power transfer device. For example, an equivalent series inductance of the plurality of stack inductors can substantially compensate a parallel capacitance of the parallel tuned resonant circuit. The at least two phases of the multilevel converter can be configured to connect across a DC source, and each of the at least two phases can form a DC current path that extends from the DC source through the upper stack, the at least one stack inductor and the lower stack without extending through the tuned coil.

Some embodiments of the resonant wireless power transfer device comprise a coil, at least one tuning capacitor that tunes the coil for resonance at an operating frequency of the resonant wireless power device, and a multilevel converter connected to the coil and the tuning capacitor. In at least some embodiments, the multilevel converter comprises an upper stack with at least one submodule and a lower stack with at least one submodule. The coil and the at least one tuning capacitor can connect to the multilevel converter at a point between the upper stack and the lower stack.

In some embodiments, the at least one tuning capacitor is arranged in parallel with the coil, and the multilevel converter comprises at least one inductor that is arranged in series with the coil. The equivalent series inductance of the at least one inductor can be matched to the capacitance of the at least one tuning capacitor. The equivalent series inductance of the at least one inductor, the equivalent capacitance of the at least one tuning capacitor and the coil can comprise a tuned LCL circuit at the operating frequency of the resonant wireless power transfer device. In some embodiments, the at least one submodule of the upper stack is connected to the at least one submodule of the lower stack by at least one DC inductor.

For wireless power transfer, the converter is configured to produce an alternating voltage waveform (e.g. a square voltage waveform) at the resonant frequency of the primary compensation network. For example, the converter can comprise a controller (such as a micro-controller, ASIC or FPGA) that monitors the state of the resonant circuit (e.g. via a current sensor that detects zero crossings in the resonant current) and switches the submodules to produce a square voltage waveform that coincides with the resonating current in the compensation network. The converter shown in FIG. 6, comprises a controller that is configured to switch the submodules at the zero crossing of the resonant current in the primary compensation network (e.g. the controller switches the submodules into and out of a circuit with the primary compensation network at about the same time as the resonant current changes direction within the primary compensation network).

In at least some embodiments, the controller can be configured to switch the submodules in advance of, or with a delay to, the resonant current zero crossing. For example, the controller can be configured to manipulate switch-on and/or switch-off of the submodule switches to improve switching performance (e.g. reduce switching losses) or mitigate the chance of damaging the submodule switches. In some embodiments, the controller is configured to maintain the voltage of the submodule capacitors at or near a nominal voltage by selecting switching patterns that are responsive to the charge state of each capacitor. For example, the controller can switch the submodules to preferentially discharge overcharged capacitors (i.e. when the capacitor voltage exceeds the nominal voltage for the converter) and/or preferentially charge undercharged capacitors (i.e. when the capacitor voltage is below the nominal voltage).

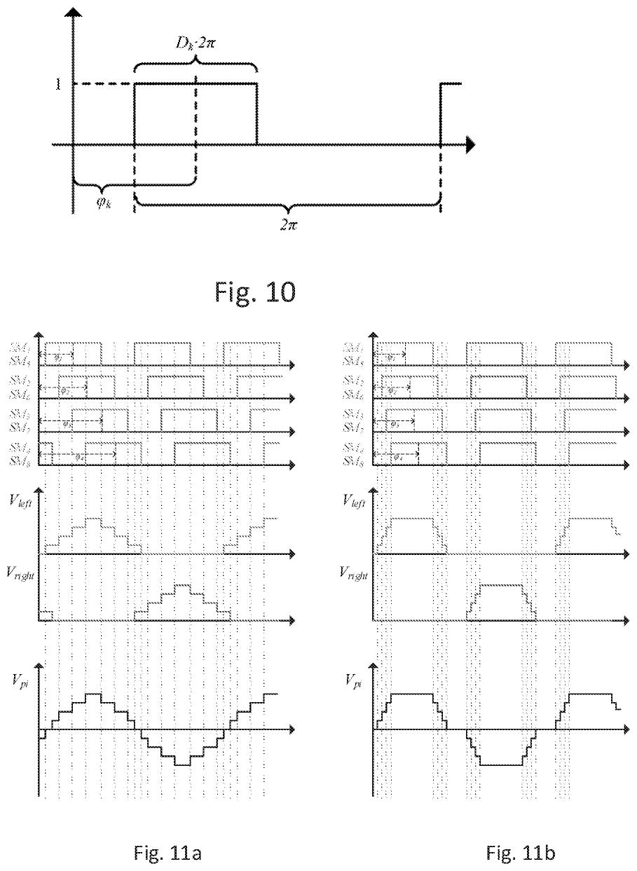

The submodule capacitors function as voltage sources at steady-state. Each submodule produces a voltage pulse when switched into a circuit with the compensation network. An exemplary submodule voltage waveform is shown in FIG. 10. The square voltage waveform is centred at ϕₖ radians and has a width of Dₖ·2π. In at least some embodiments, the converter modulates the AC voltage waveform across the compensation network by controlling the relative phase angle (ϕₖ) between the square voltage waveforms created by the submodules.

A series of exemplary voltage waveforms depicting phase angle control for the converter of FIG. 4 are presented in FIG. 11. The waveforms in the graphic at the top of FIG. 11 represent the state of each submodule (i.e. either inserted into a circuit with the compensation network or bypassed). The waveforms in the middle graphic represent the voltage waveform across the left (V_{left}) and right (V_{right}) stacks and the bottom graphic represents the voltage waveform across the compensation network (Vₚᵢ). These waveforms are produced without duty cycle manipulation. Each submodule is switched with the same duty cycle (D).

FIG. 11a shows phase angle control for medium power applications (e.g. a 3.7 kW electric vehicle charger). The voltage waveform (Vₚᵢ) across the compensation network in FIG. 11a approximates a stepwise pyramid. This is achieved by controlling the offset between the switch-on and switch-off times for the submodule of each stack (i.e. the phase angle between the submodules). The positive component (V_{left}) of the waveform is generated by staggering the phase angle of the submodules (SM₁-SM₄) in the left hand submodule stack. The negative component (V_{right}) is generated by staggering the phase angle of the submodules (SM₅-SM₈) in the right submodule stack. The right and left stacks are switched out of phase (i.e. a phase angle shift of 180°) to produce a bipolar waveform.

The converter staggers the submodules in each stack by one quarter of the common duty cycle (D) in FIG. 11a. For example, the phase angle (ϕ₂) of the second submodule (SM₂) in the left hand stack equal to the phase angle (ϕ₁) of the first submodule (SM₁) is incremented by one quarter of the duty cycle (¼·D). At the beginning of the switching cycle, the converter switches the first submodule from the left stack (SM₁) into a circuit with the compensation network. The remaining submodules (SM₂-SM₄) from the left stack are bypassed and the voltage (V_{left}) across the left hand stack is equal to the capacitor voltage (V_{C}) of the first submodule (SM₁). When the on-time for the first submodule (SM₁) reaches one quarter of the duty cycle (D), the converter switches the second submodule (SM₂) into the circuit and the voltage (V_{left}) across the left hand stack increases by an amount equal to the capacitor voltage of the second submodule (SM₂). The stack voltage (V_{left}) is equivalent to twice the nominal capacitor voltage (2·V_{C}) when the converter is adequately balancing the charge of the submodule capacitors. The converter switches the third and fourth submodules from the left hand stack with the same sequence. At midway through the duty cycle of the first submodule (SM₁), the converter switches in the third submodule (SM₃) to increase the voltage (Viet) across the left hand stack to three times the capacitor voltage (3·V_{C}) and at three quarters through the duty cycle of the first submodule (SM₁), the converter switches in the fourth submodule (SM₃) to increase the voltage (V_{left}) across the left hand stack to four times the nominal capacitor voltage (4·V_{C}) of the converter.

The four submodules (SM₁-SM₄) of the left stack are collectively switched into a circuit with the compensation network for one quarter of a duty cycle. The converter then switches the submodules (SM₁-SM₄) out of the circuit in reverse order—starting with the first submodule (SM₁) at the completion of a full duty cycle. The converter switches the submodules (SM₅-SM₈) of the right stack with the same sequence. In the illustrated embodiment, the submodules of the right stack (SM₅-SM₈) are switched at a phase angle (ϕ) that is offset from the corresponding submodule (SM₁-SM₄) in the left hand stack by 180°. For example, the third submodule from the second stack (SM₇) is switched with a phase angle (ϕ₇) that is shifted 180° from the phase angle (ϕ₃) of the third submodule from the first stack (SM₃). In most embodiments, the switching order will change dynamically as the converter actively balances the capacitor voltages and/or regulates the nominal voltage (V_{C}) of the submodule capacitors.

The stack voltage waveforms (V_{right} and V_{left}) shown in FIG. 11a overlap as the converter transitions from the left stack to the right stack. In the illustrated embodiment, the duty cycle of the fourth submodule from the left stack (SM₄) overlaps with the duty cycle of the first submodule from the right stack (SM₅). This produces no net voltage across the compensation network (i.e. Vₚᵢ=0) when the capacitor voltages are balanced and/or both submodules (SM₄ and SM₅) are operating at the nominal voltage (V_{C}) for the switching state of the converter. The stack voltages overlap for an eighth of the duty cycles (D) in the Illustrated embodiment. The converter can control the duration of inter-stack overlap and the number of submodules from each stack that are concurrently switched into a circuit with the DC power source to regulate the voltage of the submodule capacitors.

FIG. 11b is shows phase angle control for higher power applications (e.g. an 11.1 kW electric vehicle charger). The voltage waveform (Vₚᵢ) across the compensation network in FIG. 11b approximates a truncated stepwise pyramid. The waveform is still achieved by controlling the offset between the switch-on and switch-off times for the submodule of each stack (i.e. the phase angle between the submodules). But in the example shown in FIG. 11b, the converter reduces the phase angle (ϕ) shift for the submodules within each stack to cause greater overlap between the submodules. The phase angles (ϕ) for the right (SM₅-SM₈) and left (SM₁-SM₄) stacks are again shifted by 180° to produce a bipolar waveform.

The converter staggers the submodules in each stack by a fixed phase angle (ϕ) in FIG. 11b. The switching sequence is the same as shown in FIG. 11a, but the phase angle (ϕ) shift between the submodules in FIG. 11b is significantly less than the one quarter duty cycle shift depicted in FIG. 11a. This creates greater overlap between the submodules of each stack—increasing the time that the submodules are concurrently switched into a circuit with the compensation network. It also eliminates overlap between the stack voltage waveforms (V_{right} and V_{left}) as the converter transitions from the left stack to the right stack. In at least some embodiments, the converter can use the time that separates the stack voltage waveforms to charge capacitors and/or balance capacitor voltages. For example, the converter can switch an equal number of submodules from each stack into a circuit with the DC power source to create the zero voltage segment at the transition between stacks. In some embodiments, the converter can switch in additional submodules during the ramped sections of the truncated pyramid to balance the charge levels of the submodule capacitors. For example, the converter can switch in two submodules from the left hand stack and one submodule from the right stack to produce the first step of the voltage waveform (Vₚᵢ) shown in FIG. 11b.

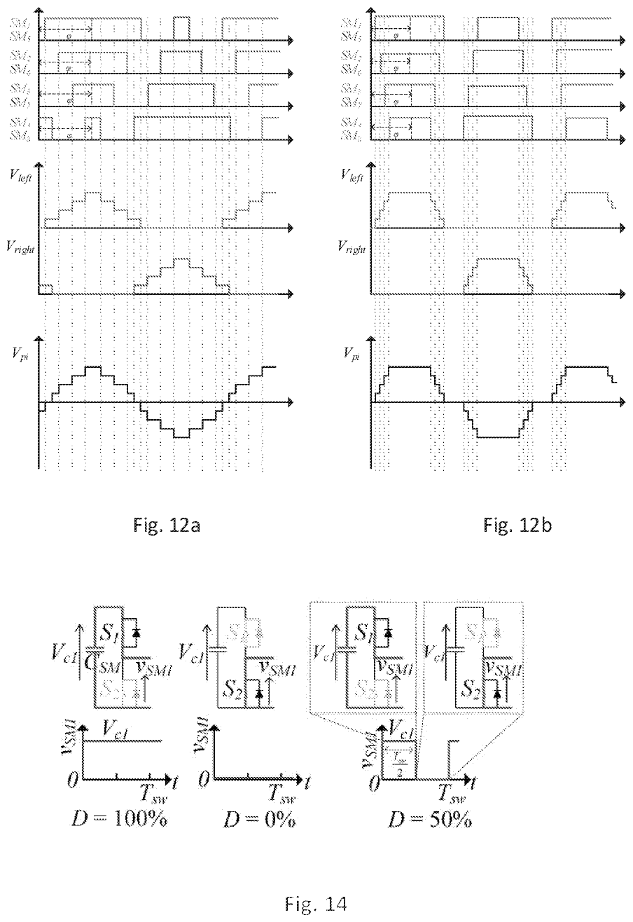

In at least some embodiments, the converter is configured to control the switching duty cycle of the submodules to create a voltage waveform (Vₚᵢ) across the compensation network and/or regulate the power output from the inductive power transfer primary. The duty cycle of a submodule represents the fraction of the converter switching period (T_{sw}) that the submodule is switched into a circuit with the compensation network and/or the ratio of time that the submodule is switched into a circuit with the compensation network compared to the time that the submodule is bypassed. A series of exemplary waveforms depicting duty cycle control for the converter of FIG. 4 are presented in FIG. 12.

The waveforms in the graphic at the top of FIG. 12 represent the state of each submodule (i.e. either inserted into a circuit with the compensation network or bypassed). The waveforms in the middle graphic represent the voltage waveform across the left (V_{left}) and right (V_{right}) stacks and the bottom graphic represents the voltage waveform across the compensation network (Vₚᵢ). The voltage waveform across the submodule stacks (V_{left} and V_{right}) and the compensation network (Vₚᵢ) shown in FIG. 12 are identical to the corresponding waveforms in FIG. 11. But the waveforms in FIG. 12 are produced without phase angle manipulation. Each submodule is switched with the same phase angle (ϕ).

For duty cycle control, the converter modulates the duration, within the stack switching cycle, that the submodules are switched into a circuit with the compensation network and/or bypassed. This corresponds to the modulating the width (Dₖ·2π) of the submodule voltage pulse shown in FIG. 10. For example, the converter can implement duty cycle control to produce the stack voltage waveforms (V_{left} and V_{right}) depicted in FIGS. 6a and 6b by manipulating the width of the voltage pulse contributed by the submodules of each stack. The submodule pulses are centred at the geometric centre of the stack voltage waveform (V_{left} and V_{right}) when the converter implements duty cycle control in isolation (i.e. without phase angle control). The converter can implement duty cycle control in isolation or in combination with phase angle control.

FIG. 12a is shows duty cycle control for medium power applications (e.g. a 3.7 kW electric vehicle charger). The voltage waveform (Vₚᵢ) across the compensation network in FIG. 12a is identical to the stepwise pyramid presented in FIG. 12a. This is achieved by controlling the time that each submodule is inserted into a circuit with the compensation network and/or bypassed during each switching period (i.e. the width of the voltage pulse from each submodule). The positive component (V_{left}) of the waveform is generated by manipulating the duty cycle of the submodules (SM₁-SM₄) in the left submodule stack. The negative component (V_{right}) is generated by manipulating the duty cycle of the submodules (SM₅-SM₈) in the right submodule stack. The voltage pulses created by the submodules of each stack are centred around a common phase angle (ϕ) and the right and left stacks are switched out of phase (i.e. a phase angle shift of 180°) to produce a bipolar waveform.

The converter switches one submodule from each stack into a circuit with the compensation network for half of the switching period (i.e. the duration of the stack switching cycle) in FIG. 12a. The rest of the submodules are switched with a duty cycle that is less than half the switching period. The first submodule (SM₁) of the left stack and the fourth submodule (SM₈) of the right stack are depicted with the longest duty cycle. The duty cycles for the submodules in the left stack progressively reduce from the first (SM₁) submodule onwards—with the fourth submodule (SM₄) having the shortest duty cycle. The duty cycles for the submodules in the right stack progressively increase from the first (SM₅) submodule onwards—with the fourth submodule (SM₈) having the longest duty cycle. The voltage pulse produced by each of the submodules (SM₁-SM₈) corresponds to a step in the stepwise pyramidal waveform shown in the voltage waveforms for the stacks (V_{left} and V_{right}) and compensation network (Vₚᵢ).

At the beginning of the switching cycle, the converter switches the first submodule from the left stack (SM₁) into a circuit with the compensation network. The remaining submodules (SM₂-SM₄) from the left stack are bypassed and the voltage (V_{left}) across the left stack is equal to the capacitor voltage of the first submodule (SM₁). The converter incrementally increases the stack voltage (V_{left}) by switching in the other submodules (SM₂-SM₄) at regular intervals during the stack switching cycle. The switching intervals are evenly spaced across the stack switching cycle in the FIG. 12a. The converter switches in the second submodule from the left stack (SM₂) at the conclusion of the first switching interval. This increases the stack voltage to twice the nominal capacitor voltage (2·V_{C}) when the converter is adequately balancing the charge of the submodule capacitors. The converter switches the third and fourth submodules from the left stack with the same sequence. At the conclusion of the second switching interval, the converter switches in the third submodule to increase the stack voltage (V_{left}) to three times the nominal capacitor voltage (3·V_{Cl}) and at the conclusion of the third switching interval, the converter switches in the fourth submodule (SM₃) to increase the voltage (V_{left}) across the left stack to four times the nominal capacitor voltage (4·V_{C}) of the converter.

The four submodules (SM₁-SM₄) of the left stack are collectively switched into a circuit with the compensation network for the duration of the fourth switching interval. The converter then switches the submodules (SM₄-SM₁) out of the circuit in the same order they were switched in—starting with the fourth submodule (SM₄) at the completion of the fourth interval. The converter switches the submodules (SM₈-SM₅) of the right stack with the reverse sequence, starting with the fourth submodule SM₈ and progressively switching in the other submodules (SM₇-SM₅) at regular intervals. The shape of the voltage waveform (V_{right}) across the right stack is identical to the shape of the voltage waveform (V_{left}) across the left stack.

The stack voltage waveforms (V_{right} and V_{left}) shown in FIG. 12a overlap as the converter transitions from the left stack to the right stack. In the illustrated embodiment, the duty cycle of the first submodule from the left stack (SM₁) overlaps with the duty cycle of the fourth submodule from the right stack (SM₈). This produces no net voltage across the compensation network (i.e. Vₚᵢ=0) when the capacitor voltages are balanced and/or both submodules (SM₁ and SM₈) are operating at the nominal capacitor voltage (V_{C}). The stack voltages (V_{left} and V_{right}) overlap for half the switching interval at the transition from the left stack to the right stack in the illustrated embodiment (the seventh switching interval).

FIG. 12b shows duty cycle control for higher power applications (e.g. an 11.1 kW electric vehicle charger). The voltage waveform (Vₚᵢ) across the compensation network in FIG. 12b is identical to the truncated stepwise pyramid presented in FIG. 11b. But in the example shown in FIG. 12b, the converter manipulates the duty cycle (D) for the submodules within each stack to cause greater overlap between the submodules. The phase angles (ϕ) for the right (SM₅-SM₈) and left (SM₁-SM₄) stacks are again shifted by 180° to produce a bipolar waveform. The voltage pulses created by the submodules of each stack are centred around a common phase angle (ϕ).

The converter manipulates the duty cycle of the submodules in each stack by a fixed switching interval in FIG. 12b. The switching sequence is the same as the sequence shown in FIG. 12a, but the incremental change in duty cycle (D) between the submodules in FIG. 12b is significantly less than the switching interval depicted in FIG. 11a. This creates greater overlap between the submodules of each stack—increasing the time that the submodules are concurrently switched into a circuit with the compensation network. It also reduces duty cycle variation between the submodules. In at least some embodiments, reducing duty cycle variation can simplify capacitor voltage balancing and/or improve capacitor voltage stability as there is less discharge variation across the switching cycle.

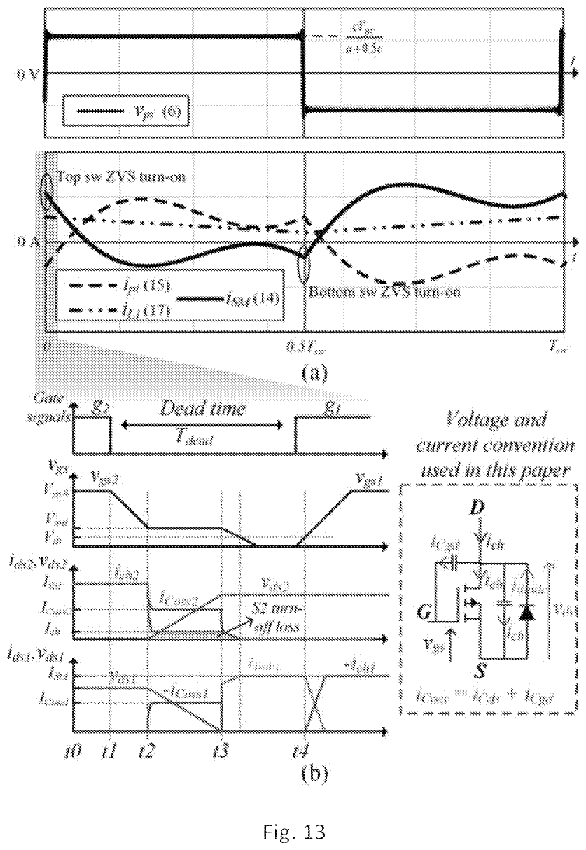

The converters shown in FIGS. 1-4 can be configured soft switch and/or to switch at zero voltage (e.g. zero voltage turn-on) with selective duty cycle modulation. In at least some embodiments, the converter can be configured to soft switch by timing submodule transitions (i.e. inversion of the half-bridge switch states) to substantially coincide with zero crossing in the resonant waveform (as shown in FIG. 13). For example, the half-bridge switches of the submodules can be switched at zero voltage when the converter uses selective duty cycle modulation to generate a square voltage waveform at the resonant frequency of the compensation network (instead of the “stepped” or “staircase” waveforms shown in FIGS. 6 and 7). The converter generates a square voltage waveform across the compensation network by switching the submodules with a subset of duty of cycles that coincide with the zero crossings of the resonant waveform in the compensation network.

A series of exemplary waveforms, depicting soft switching for a multilevel resonant converter with MOSFET switches, are presented in FIG. 13. The waveforms in FIG. 13a represent the voltage and current for the compensation network of an inductive power transfer primary over a full converter switching cycle (i.e. one resonant cycle of the compensation network). The square waveform in the top graphic of FIG. 13a represents the voltage (Vₚᵢ) across the compensation network. The current waveforms in the lower graphic of FIG. 13a represent the compensation network current (iₚᵢ) shown with the dashed line, the DC inductor current (i_{L1}) shown with the dash-dot line, and the submodule current (i_{SM}) shown with the solid line. The submodule current (i_{SM}) is the sum of the DC current (including a small ripple current) represented by the DC inductor current (i_{L1}) and the AC current represented by the compensation network current iₚᵢ.

In at least some embodiments, the converter is configured to stagger the switching signals for the submodule switches to ensure there is negligible voltage across the switches when they undergo turn-on. For example, the converter can introduce a dead time (when neither switch is conducting) when the switches of a half-bridge submodule are inverted. The gate signals (g₁ and g₂) presented in the top graphic of FIG. 13b show a dead time between the low-side switch (S₂) of the half-bridge submodule transitioning to a non-conducting state and the high-side switch (S₁) of the half-bridge transitioning to a conducting state. The dead time between the gate signals (g₁ and g₂) coincides with the first zero crossing (at time t=0) shown in the resonant voltage waveform of FIG. 13a. The submodule current (i_{SM}) during the transition is circled in the current waveform of FIG. 13a (at time t=0).

In the illustrated embodiment, offsetting the gate signals for the submodule switches allows the body diode of the switch undergoing turn-on to start conducting before the switch changes state. For example, in at least some embodiments the converter is configured to control the dead time between the low-side switch (S₂) undergoing turn-off and the high-side switch (S₁) undergoing turn-on to allow the body diode of the high-side switch (S₁) to start conducting before the high-side switch (S₁) changes states. Causing the switches to transition when the body diode is conducting is sufficient to ensure zero-voltage turn-on (i.e. there is approximately and/or effectively 0V across the switch when the body diode is conducting).

The waveforms in FIG. 13b represent the gate signals, voltage and current waveforms for the MOSFET switches of a half-bridge submodule. The submodule is transitioning to a state where the submodule capacitor is switched into a circuit with the primary compensation network and the timescale for the MOSFET waveforms is approximately an order of magnitude smaller than the timescale for the converter switching cycle shown in FIG. 13a. The top two graphics of FIG. 13b depict the gate signals (g₁ and g₂) and the gate source voltage (V_{gs1} and V_{gs2}) respectively for the two MOSFET switches (S₁ and S₂) of the half-bridge submodule. The lower two graphics represent the drain source voltage (V_{ds1} and V_{ds2}) and the internal currents for the high-side MOSFET switch (S₁) and the low-side MOSFET switch (S₂) respectively. An equivalent circuit showing the parasitic capacitance (Cₒₛₛ) within the MOSFET switches is depicted to the right. The submodule state during the switching sequence is shown schematically underneath the waveform graphics.

The waveforms shown in FIG. 13b start with current (i_{SM}) flowing into the submodule stack and the submodule capacitor bypassed. The current (i_{SM}) path through the submodule is shown in the first schematic corresponding to the interval 0-t₂. The low-side switch (S₂) in a conducting state. The high-side switch (S₁) in a non-conducting state. The voltage (V_{ds1}) waveform for the high-side switch (S₁) and the current (i_{ch2}) waveform for the low-side switch (S₂) are non-zero during this interval. At time t₁, the gate signal (g₂) for the low-side switch (S₂) transitions to zero (i.e. g₂≤0V). This causes the gate source voltage (V_{gs2}) to drop from the operating voltage (V_{gs,0}) to the Miller Plateau voltage (Vₘᵢₗ) during the interval t₁-t₂ as the gate source capacitance (not shown in the equivalent circuit) discharges. The submodule current (i_{SM}) continues to flow through the low-side switch (S₂). The process is substantially lossless as the voltage (V_{ds2}) across the switch (S₂) and current (i_{ch}) through the switch (S₂) remain substantially constant.

During the interval t₂-t₃ (corresponding to the Miller Plateau), the submodule current (i_{SM}) charges the parasitic capacitances (Cₒₛₛ₂) of the low-side switch (S₂) and discharges the parasitic capacitances (Cₒₛₛ₁) of the high-side switch (S₁). The remaining charge in the gate drain capacitor (C_{gd2}) of the low-side switch (S₂) is discharged to the gate terminal and the capacitor (C_{gd2}) is charged to the drain source voltage (V_{ds2}) by the submodule current (I_{SM}). The drain source capacitance (C_{ds}) of the low-side switch is charged from 0V to the drain source voltage (V_{ds2}) and the drain source capacitance (C_{ds1}) of the high-side switch is discharged from the drain source voltage (V_{ds1}) to 0V at the same time. In the illustrated embodiment, the majority of the submodule current (i_{SM}) flows to the parasitic capacitances (Cₒₛₛ₁ and Cₒₛₛ₂). This reduces the current (i_{ch2}) through the low-side switch (i_{ch2}=i_{SM}−iₒₛₛ₁−iₒₛₛ₂) and limits the turn-off losses (the shaded area under the i_{ch2} waveform) to a level that is equivalent to soft switching and/or effectively zero current turn-off.

The body diode of the high-side switch (S₁) starts conducting when the parasitic capacitances (Cₒₛₛ₂ and Cₒₛₛ₁) reach saturation (corresponding to the end of the Miller Plateau at time t₃). At the same time, the current (i_{ch2}) through the low-side switch (S₂) decays as the gate source voltage (V_{gs2}) drops toward the threshold voltage (Vₜₕ). The low-side switch (S₂) stops conducting once the gate source voltage (V_{gs2}) drops below the threshold voltage (Vₜₕ) and the full submodule current (i_{SM}) flows through the body diode of the high-side switch (S₁). In the illustrated embodiment, the converter delays the gate signal (g₁) for the high-side switch (S₁) until the body diode is conducting substantially all of the submodule current (i_{SM}). This ensures that the voltage across the high-side switch (the drain source voltage V_{ds1}) is effectively zero.

The converter can be configured to soft switch the submodule switches (S₁ and S₂) when the submodule transitions back to a bypassed state. For example, the converter can stagger the gate signals (g₁ and g₂) for the submodule switches to introduce a dead time between the high-side switch (S₁) undergoing turn-off and the low-side switch (S₂) undergoing turn-on. This allows the body diode of the low-side switch (S₂) to start conducting before the high-side switch (S₁) changes states. In the example depicted in FIG. 13, the dead time switching sequence when the submodule transitions to a bypassed state coincides with the second zero crossing (at time t=0.5T_{sw}) shown in the resonant voltage waveform of FIG. 13a. The submodule current (i_{SM}) during this is dominated by the AC current flowing into the compensation network (represented by the compensation network current iₚᵢ). This ensures that current (i_{SM}) is flowing out of the submodule stack during the transition and the body diode of the low-side switch (S₂) is conducting before the switch (S₂) transitions. The transition current is circled in current waveform shown in FIG. 13a (at time t=0.5 T_{sw}). The MOSFET switches progress through the transitory states shown FIG. 13b when the submodule transitions to a bypassed state and the gate signals for the switches need to be staggered to allow sufficient dead time for the parasitic capacitances to adequately charge/discharge.

In at least some embodiments, the converter can be configured to generate a square voltage waveform across the compensation network, and/or time submodule transitions (i.e. inversion of the half-bridge switch states) to substantially coincide with zero crossing in the resonant waveform, by restricting the submodules to switch with a duty cycle selected from the group consisting of 0%, 50% or 100%. The submodule duty cycle represents the portion of the resonant cycle (equivalent to the switching period T_{sw} of the converter) that the submodule capacitor is switched into a circuit with the compensation network. This is done without phase angle manipulation to generate a square waveform at the resonant frequency of the compensation network in the illustrated embodiment (i.e. each of the submodules is switched with the same phase angle ϕ).

The submodule switching states that correspond to 0%, 50% and 100% duty cycles are shown schematically in FIG. 14. A duty cycle of 100% represents a submodule capacitor that is switched into a circuit with the compensation network for a complete resonant cycle of the compensation network (i.e. the switching period of the converter). For the inductive power transfer primary shown in FIG. 4, a duty cycle of 100% represents switching the capacitor of a submodule into a circuit with the compensation network for the complete switching cycle of both submodule stacks. A duty cycle of 50% represents a submodule capacitor that is switched into a circuit with the compensation network for half a resonant cycle of the compensation network (i.e. half of the converter switching period). For the inductive power transfer primary shown in FIG. 4, a duty cycle of 50% represents switching the submodule capacitor into a circuit with the compensation network for the complete switching cycle of the submodule stack that the capacitor is associated with (i.e. submodules SM₁-SM₄ are switched in for the switching cycle of the left stack and submodules SM₅-SM₅ are switched in for the switching cycle of the right stack). A 0% duty cycle represents a submodule that bypassed for the entire resonant cycle.

An exemplary method for operating a resonant inductive power transfer primary comprises soft switching the submodules of the multilevel converter to produce a repeating square AC waveform at the resonant frequency of the compensation network. Soft switching can be achieved by aligning the submodule transitions (e.g. inversion of the half-bridge switches shown in FIG. 14) with the resonant voltage zero crossings in the compensation network. For example, each of the submodules can be switched into a circuit with the compensation network for no less than half of the resonant period (i.e. for half of the resonant waveform) when the resonant voltage is changing direction. The method can comprise complementarily switching the at least two switches of each of the plurality of submodules to substantially coincide with zero crossings in the compensation network.

Alternating submodules from a first limb of the converter (e.g. the left stack of the converter shown in FIG. 4) with submodules from a second limb of the converter (e.g. the right stack of the converter shown in FIG. 4) can be used to produce a square voltage waveform across the compensation network. In some embodiments, the method comprises controlling the power transferred to an inductive power transfer secondary by controlling the number of submodules, from the first limb of the converter, that are switched into a circuit with the compensation network relative to the number of submodules, from the second limb of the converter, that are switched into the circuit with the compensation network, for each half cycle of the square voltage waveform.

The converter can be configured to switch the submodules at discrete frequencies. The frequencies employed by the converter are dependent on the resonant frequency of the compensation network. For example, the submodules can be switched at a frequency that corresponds to the resonant frequency of the compensation network or a frequency that corresponds to a fraction of the resonant frequency of the compensation network (e.g. the submodules can be switches at a frequency that corresponds to half the resonant frequency of the compensation network). In some embodiments, the converter can be limited to a maximum switching frequency that is no greater than the resonant frequency of the compensation network to prevent the voltage across the compensation network deviating from a square waveform. The switching frequency of the converter is inversely proportional to the switching period of the submodule switches (i.e. the combined on-time and off-time of a submodule switch during each switching cycle at the prescribed duty cycle). In at least some embodiments, the converter comprises a closed loop controller that monitors the elapsed time between single sided switch transitions (e.g. leading edge transitions from a non-conducting state to a conducting state—or—falling edge transitions from a conducting state to a non-conducting state) to determine the switching period of the submodule switches and switching frequency of the submodules/converter.

In some embodiments, the method comprises selecting a square voltage waveform, from a finite number of square voltage waveforms, to control the power made available for inductive power transfer. Each of the finite number of square voltage waveforms typically has a discrete amplitude, and the method comprises selectively inserting the plurality of submodules into a circuit with the compensation network to produce the selected square voltage waveform across the compensation network.

Another exemplary method for operating a resonant inductive power transfer primary comprises driving the resonant inductive power transfer primary at discrete power levels by operating a multilevel converter at the resonant frequency of the resonant inductive power transfer primary and switching the submodules of the converter with a duty cycle selected from the group of duty cycles consisting of: 0%, 50% and 100%. In at least some embodiments, the method comprises switching all of the submodules of the multilevel converter with a duty cycle that is selected from the group of duty cycles consisting of: 0% and 50%. The converter can be configured to not hard switch the switches of the submodules at turn-on.

The method can comprise concurrently switching: a first submodule with a duty of 0%; a second submodule with a duty of 50%; and a third submodule with a duty of 100%. The converter can be configured to produce a finite number of voltage waveforms each having a discrete time invariant magnitude. For example, a converter for some medium to high power applications can be configured to produce between 20 and 40 discrete voltage waveforms. A converter for some lower power applications can be configured to produce between 4 and 20 discrete voltage waveforms. In some embodiments, the converter is configured to produce less than 30 voltage waveforms with different amplitudes.

Another exemplary method for operating a resonant inductive power transfer primary comprises switching a multilevel inverter to cause inductive power transfer from the resonant inductive power transfer primary by switching each of the converter submodules, with zero voltage turn-on, to selectively insert the submodules into a circuit with a compensation network of the resonant inductive power transfer primary. In at least some embodiments, the method can comprise producing a square voltage waveform between a first subset of converter submodules and a second subset of converter submodules. The converter can be configured to regulate an amplitude of the square voltage waveform to control power transfer from the resonant inductive power transfer primary.

The method can comprise selecting an amplitude for the square voltage waveform, from a finite number of discrete amplitudes, and controlling the number of submodules in the first subset that are inserted into the circuit with the compensation network relative to the number of submodules in the second subset that are inserted into the circuit with the compensation network to achieve the selected amplitude for the square voltage waveform. In at least some embodiments, the method comprises switching all of the submodules from the second subset out of the circuit with the compensation network for a half cycle of the square voltage waveform, and switching at least one submodule from the first subset into the circuit with the compensation network for the half cycle of the square voltage waveform. The converter can be configured to switch each of the plurality of submodules with a switching frequency that is no higher than the resonant frequency of the compensation network.

In some embodiments, the converter is configured to switch at least one submodule from the first subset into the circuit with the compensation network, and concurrently switching at least one submodule from the second subset out of the circuit with the compensation network, to create the first half cycle of the square voltage waveform, and vice versa to create the second half cycle of the square voltage waveform.

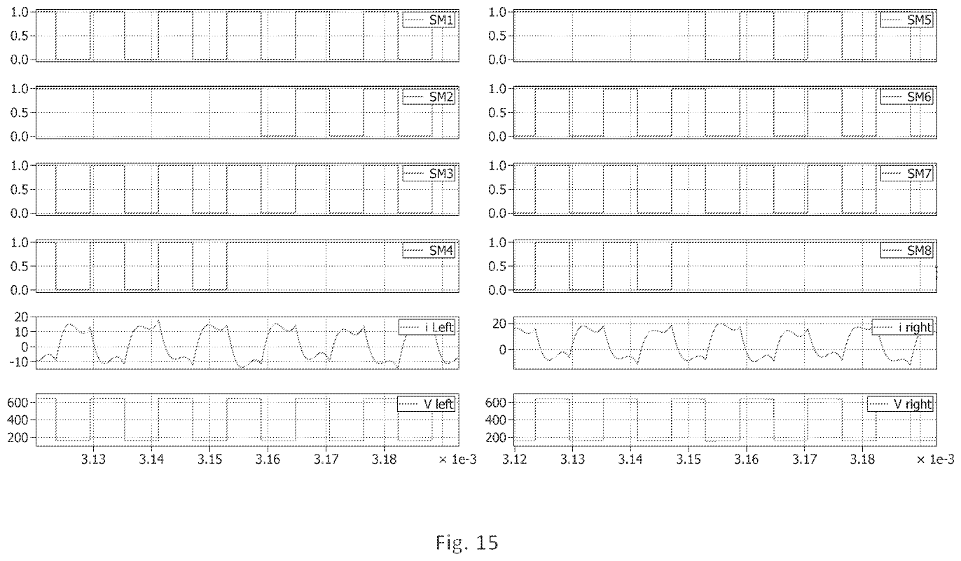

A series of exemplary voltage waveforms showing duty cycle control that enables zero voltage switching and/or soft switching for the inductive power transfer primary of FIG. 4 are presented in FIG. 15. The first four waveforms on the left side represent the state of the submodules for the left stack (SM₁-SM₄). The fifth and sixth waveforms on the left side represent the stack current and stack voltage respectively for the left stack. The first four waveforms on the right side represent the state of the submodules for the right stack (SM₅-SM₈). The fifth and sixth waveforms on the right side represent the stack current and stack voltage respectively for the right stack. In the illustrated embodiment, the converter generates a periodic square voltage waveform across the primary compensation network by switching three submodules from each stack with a duty cycle of 50%. The converter switches the remaining submodule from each stack with a duty cycle of 100%. The converter can be configured to dynamically control the switching priority within each stack (e.g. which submodule is switched at 100%) to regulate the voltage of the submodule capacitors across the stack.

The waveforms shown in FIG. 15 extend across six complete switching cycles of the converter at the resonant frequency of the primary compensation network. For the embodiment shown in FIG. 4, this comprises twelve stack switching cycles (six switching cycles from each stack). The converter operates the second submodule from the left stack (SM₂) and the first submodule from the right stack (SM5) with a duty cycle of 100% for the first three converter switching cycles. The converter operates the other submodules with a duty cycle of 50% during this time. The converter transitions the fourth submodule from the left stack (SM₄) and the fourth submodule from the right stack (SM8) to a duty cycle of 100% at the conclusion of the third converter switching cycle. The other submodules (including the second submodule from the left stack (SM₂) and the first submodule from the right stack (SM5)) are switched with a duty cycle of 50% for the remainder of the depicted waveforms.

The waveforms presented in FIG. 15 start with the submodules of the left stack (SM₁-SM₄) switched into a circuit with the compensation network and the submodules form the right stack bypassed. The exception is the first submodule (SM₅) of the right stack, which is operating with a duty cycle of 100% and consequently is switched into a circuit with the compensation network concurrently with the submodules from the left stack (SM₁-SM₄). In this state, the converter produces a voltage across the left stack that is four times the nominal capacitor voltage (4·V_{C}) of the converter and a voltage across the right stack that is equal to the nominal capacitor voltage (V_{C}) of the converter. This results in a voltage difference across the compensation network, from the left stack to the right stack, which is three times the nominal capacitor voltage of the converter (3·V_{C}).

The converter reverses the switching state of the submodule at halfway through the resonant cycle of the compensation network (i.e. at one half the period of the resonant cycle). The first (SM₁), third (SM₃) and fourth (SM₄) submodules from the left stack are bypassed for the second half of the resonant cycle, and the second (SM₆), third (SM₇), and fourth (SM₈) submodules from the right stack are switched into a circuit with the compensation network. In this state, the converter produces a voltage across the right stack that is four times the nominal capacitor voltage (4·V_{C}) of the converter and a voltage across the left stack that is equal to the nominal capacitor voltage (V_{C}). The voltage difference across the compensation network, from the right stack to the left stack, is three times the nominal capacitor voltage of the converter (3·V_{Cl}).

The converter switches both stacks with the same duty cycle pattern to create a repeating square voltage waveform across the compensation network. The pulse trains (i.e. the voltage waveforms for the submodules that are switched at 50%) for the two stacks are offset by 180°.

The submodules modules from the right stack that are switched at 50% are bypassed when the submodules modules from the left stack that are switched at 50% are switched into a circuit with the compensation network (and vice versa). This creates a voltage pulse train of the converter at the resonant frequency of the compensation network. The amplitude of the pulse train across each stack is dependent on the submodules within the stack that are switched with a duty cycle of 50%. Submodules that are switched with a duty cycle of 0% (i.e. submodules that are bypassed for the resonant cycle) do not contribute to the stack voltage waveform (V_{Left} and V_{Right}). Submodules that are switched with a duty cycle of 100% introduce a persistent voltage component in the stack voltage waveform (i.e. a voltage component that is present for both half-cycles of the converter switching cycle). The stack voltage waveforms (V_{Left} and V_{Right}) shown in FIG. 15 have a persistent voltage component that is equivalent to the nominal capacitor voltage (V_{C}) for the converter switching state.

The stack current waveforms (i_{Left} and i_{Right}) shown in FIG. 15 represent the current flowing into, and out of, the right and left submodule stacks respectively. They are 180° out of phase.

Each waveform (i_{Left} and i_{Right}) comprises an AC component and a DC component (including a small ripple current). The DC current flows from the DC power source, through the respective DC inductor (L₁ and L₂) and into the submodule stack. This is similar to the DC current path illustrated in FIG. 3 for a single stack converter. The DC component of the stack current is equivalent to the inductor current (i_{L1} and i_{L2}) shown in FIGS. 2 and 4. The AC current flows from one submodule stack, through the compensation network, to the other submodule stack. This is similar to the AC current path illustrated in FIG. 3 for a single stack converter. The AC component of the stack current is equivalent to the compensation network current (iₚᵢ) shown in FIGS. 2 and 4.

The stack voltage waveforms shown in FIG. 15 combine to produce a repeating square voltage waveform across the compensation network. For the voltage convention shown in FIG. 4, the submodules from the left stack contribute the negative component of the voltage (Vₚᵢ) waveform across the compensation network. The compensation network voltage (Vₚᵢ) waveform can be constructed by superposition, combing the voltage waveform for the right stack shown in FIG. 15 with an inverted representation of the voltage waveform for the left stack. This produces a symmetric bipolar waveform. In the illustrated embodiment, the DC components in the stack waveforms cancel to produce a waveform with no DC offset across the compensation network. In at least some embodiments, the converter is configured to switch the submodule stacks with complementary duty cycle switching patterns. That is, the converter is configured to match the submodule states in the left and right stack during steady state operation to produce a balanced waveform (e.g. zero voltage offset) across the compensation network. In some embodiments, the converter is only configured to switch the submodule stacks with complementary duty cycle patterns (i.e. the converter is configured to not utilise unbalanced duty cycle switching patterns).

In at least some embodiments, the amplitude of the periodic voltage waveform across the primary compensation network can be manipulated to control the power transferred in an inductive power transfer system. For example, the inductive power transfer primary can control the switching state of a multilevel converter to regulate the power transferred to an inductive power transfer secondary that is loosely coupled to the primary.

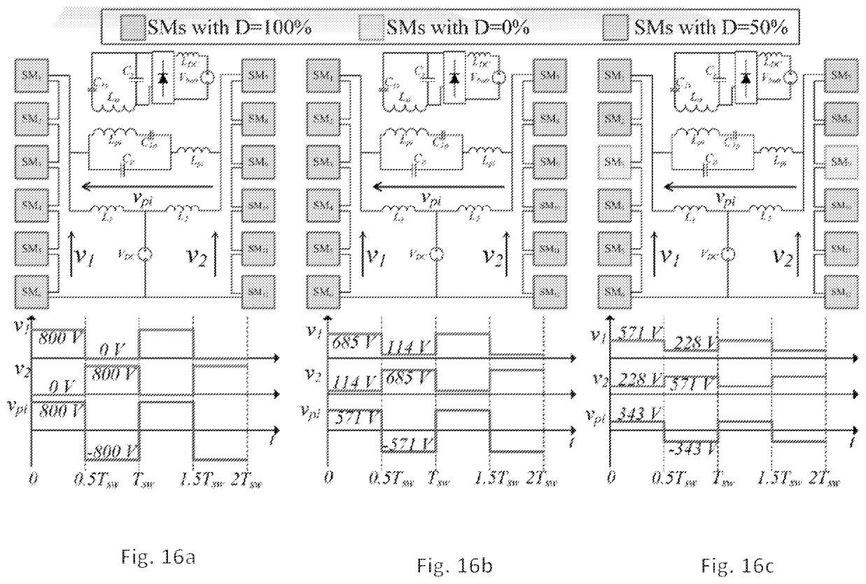

FIG. 16 shows an inductive power transfer system operating at several different power levels. The depicted inductive power transfer primary comprises a dual stack multilevel inverter with six submodules per stack and a DC power source operating at 400V. The converter shown in FIG. 16 manipulates the switching state of the submodules to produce a square voltage waveform across the primary compensation network. The compensation network waveforms shown in FIG. 16 have a time invariant magnitude that spans two switching cycles (2·T_{sw}). The inductive power transfer primary is configured to modulate the amplitude of the square waveform to regulate the power made available to the inductive power transfer secondary. In the illustrated embodiment, the converter modulates the amplitude of the compensation network waveform between a finite number of voltage waveforms (each having a discrete time invariant magnitude).

Three discrete power levels are shown in FIG. 16. The converter switching state for each power level is depicted in the circuit schematic at the top of FIGS. 16a-16c. The voltage waveforms for both submodule stacks are shown immediately below the circuit schematic for each switching state. The voltage waveform across the compensation network is shown below the stack waveforms. The power transferred to the inductive power transfer secondary, when the system operates at resonance (f_{sw}) and the secondary rectifier operates in continuous conduction mode, can be represented by equation 1:

$$P = \frac{\sqrt[k]{{L}_{pt} {L}_{st}} {\hat{v}}_{pi} {V}_{load}}{{ω}_{s w} {L}_{p i} {L}_{st\_eff}} \qquad Equation 1$$

Where:
   P=power transferred from the primary to the secondary;
   k=coupling factor between the primary and secondary coils;
   Lₚₜ=inductance of the primary coupler;
   Lₛₜ=inductance of the secondary coupler,
   \hat{v}ₚᵢ=magnitude of the compensation network voltage waveform;
   V_{load}=voltage of the secondary load (e.g. battery voltage);
   Lₚᵢ=the inductance of the primary tuning coil;
   L_{st_eff}=the effective inductance of the secondary coupler (incl. the partial series tuning capacitor C₁ₛ); and
   ω_{sw}=the angular frequency at resonance (2πf_{sw}).

FIG. 16a depicts the inductive power transfer primary operating at maximum output power. The converter is shown switching the six submodules of each stack at 50% duty cycle to create a voltage pulse of 800V across each stack (V₁ and V₂). The submodules from the right stack (SM₇-SM₁₂) are switched into a circuit with the compensation network for the first half cycle (0-0.5T_{sw}), while the submodules from the left stack (SM₁-SM₆) are bypassed. The converter inverts the switching state of the stacks midway through the resonant cycle (at time 0.5 T_{sw}). The submodules from the left stack (SM₁-SM₆) are switched into a circuit with the compensation network for the second half cycle (0.5T_{sw}-T_{sw}), while the submodules from the right stack (SM₇-SM₁₂) are bypassed. This switching configuration produces a square waveform, with peak-to-peal amplitude of 1600V, across the compensation network.

FIG. 16b depicts the inductive power transfer primary operating with high power output (corresponding to a voltage waveform (Vₚᵢ) amplitude that is approximately 70% of the waveform shown in FIG. 16a). The converter switches five submodules from each stack at 50% duty cycle. The remaining submodule in each stack is switched with a duty cycle of 100%. This creates a voltage pulse of 685V across each stack (V₁ and V₂), with a persistent voltage component of 114V.

The five submodules from the right stack that are operated with a duty cycle of 50% (SM₈-SM₁₂) are switched into a circuit with the compensation network for the first half cycle (0-0.5T_{sw}), while the corresponding submodules from the left stack (SM₂-SM₆) are bypassed. The converter inverts the switching state of the stacks midway through the resonant cycle (at time 0.5T_{sw}). The submodules from the left stack that are operated with a duty cycle of 50% (SM₂-SM₆) are switched into a circuit with the compensation network for the second half cycle (0.5T_{sw}-T_{sw}), while the corresponding submodules from the right stack (SM₈-SM₁₂) are bypassed. The first submodule from each stack (SM₁ and SM₇) is operated with a duty cycle of 100% in this example. These submodules (SM₁ and SM₇) remain switched into a circuit with the compensation network for the duration of the switching cycle shown in FIG. 16b.

This switching configuration produces a square waveform, with a peak-to-peak amplitude of 1142V, across the compensation network. The peak amplitude (571V) of the square waveform across the compensation network is lower than the amplitude of the voltage pulse produced across the stacks (V₁ and V₂). This is attributable to persistent voltage component (114V) in the stack voltage waveforms that is created by the submodules operating at a duty cycle of 100%.

FIG. 16c depicts the inductive power transfer primary operating with medium power output (corresponding to a voltage waveform (Vₚᵢ) amplitude that is approximately 40% of the waveform shown in FIG. 16a). The converter switches three submodules from each stack at 50% duty cycle. Two of the remaining submodule from each stack are switched with a duty cycle of 100% and the last submodule from each stack is switched with a duty cycle of 0%. This creates a voltage pulse of 571V across each stack (V₁ and V₂), with a persistent voltage component of 228V.

The three submodules from the right stack that are operated with a duty cycle of 50% (SM₁₀-SM₁₂) are switched into a circuit with the compensation network for the first half cycle (0-0.5T_{sw}), while the corresponding submodules from the left stack (SM₄-SM₈) are bypassed. The converter inverts the switching state of the stacks midway through the resonant cycle (at time 0.5 T_{sw}). The submodules from the left stack that are operated with a duty cycle of 50% (SM₄-SM₆) are switched into a circuit with the compensation network for the second half cycle (0.5T_{sw}-T_{sw}), while the corresponding submodules from the right stack (SM₁₀-SM₁₂) are bypassed.

The first two submodules from each stack (SM₁ and SM₂ from the left stack/SM₇ and SM₈ from the right stack) are operated with a duty cycle of 100% in this example. These submodules (SM₁, SM₂, SM₇ and SM₈) remain switched into a circuit with the compensation network for the duration of the switching cycle shown in FIG. 16c. The third submodule from each stack (SM₃ and SM₉) are operated with a duty cycle of 0%. These submodules (SM₃ and SM₉) are not switched into a circuit with the compensation network for the duration of the switching cycle shown in FIG. 16c.

This switching configuration produces a square waveform, with a peak-to-peak amplitude of 686V, across the compensation network. The peak amplitude (343V) of the square waveform across the compensation network is lower than the amplitude of the voltage pulse produced across the stacks (V₁ and V₂). This is attributable to the persistent voltage component (228V) in the stack voltage waveforms that is created by the submodules operating at a duty cycle of 100%.

In at least some embodiments, the converter is configured to modulate the amplitude of the voltage waveform across the compensation network to control the power that the inductive power transfer primary makes available to a loosely coupled secondary. The magnitude of the square voltage waveforms shown in FIG. 16 depend on the switching state of the converter submodules. The relationship between the submodule states and the magnitude of the square waveform is presented in equation 2:

$${\hat{V}}_{pi} = \frac{c}{a + 0.5 c} {V}_{DC} \qquad Equation 2$$

Where:
   \hat{v}ₚᵢ=magnitude of the compensation network voltage waveform;
   V_{DC}=voltage of the DC power source;
   a=number of submodules operating with a duty cycle of 100%;
   b=number of submodules operating with a duty cycle of 0%; and
   c=number of submodules operating with a duty cycle of 50%.

The switching state of the converter also affects the voltage of the submodule capacitors (V_{C}). The submodule capacitors are charged with current from the DC power supply—which functions as a voltage source in the illustrated embodiment. The relationship between the submodule switching states and the average voltage of the submodule capacitors (V_{C}) is presented in equation 3:

$${V}_{C} = \frac{{V}_{D C}}{a + 0.5 c} \qquad Equation 3$$

Where:
   V_{c}=the average submodule capacitor voltage;
   V_{DC}=voltage of the DC power source;
   a=number of submodules operating with a duty cycle of 100%;
   b=number of submodules operating with a duty cycle of 0%; and
   c=number of submodules operating with a duty cycle of 50%.

In at least some embodiments, the converter is configured to regulate the voltage (V_{c}) of the submodule capacitors to ensure that the converter operates within acceptable limits. For example, the converter can be configured to operate with a subset of switching states that ensure the submodule capacitor voltage (V_{c}) does not exceed the voltage rating of the submodule switches (S₁ and S₂). The converter shown in FIG. 16 can operate at twelve discrete power levels while maintaining the submodule capacitor voltage below 200V. This allows medium voltage MOSFETs to be used for the submodule switches (S₁ and S₂). The converter switching states are summarised in Table 1.

TABLE 1
The discrete switching states for the converter shown in FIG.
16 that produce a submodule capacitor voltage below 200 V.

| | Duty | Duty | Duty | | | | |
|---|---|---|---|---|---|---|---|
| Power | cycle | cycle | cycle | Submodule | | Compensation | |
| Level | 100% | 0% | 50% | Capacitor | | Network | |
| 1 | 0 | 0 | 6 | 133 | V | 800 | V |
| 2 | 1 | 0 | 5 | 114 | V | 571 | V |
| 3 | 1 | 1 | 4 | 133 | V | 533 | V |
| 4 | 1 | 2 | 3 | 160 | V | 480 | V |
| 5 | 2 | 0 | 4 | 100 | V | 400 | V |
| 6 | 2 | 1 | 3 | 114 | V | 343 | V |
| 7 | 3 | 0 | 3 | 89 | V | 267 | V |
| 8 | 3 | 1 | 2 | 100 | V | 200 | V |
| 9 | 4 | 0 | 2 | 80 | V | 160 | V |
| 10 | 3 | 2 | 1 | 114 | V | 114 | V |
| 11 | 4 | 1 | 1 | 89 | V | 89 | V |
| 12 | 5 | 0 | 1 | 73 | V | 73 | V |

Throughout the description like reference numerals have been used to refer to like features in different embodiments. Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Although this invention has been described by way of example and with reference to possible embodiments thereof, it is to be understood that modifications or improvements may be made thereto without departing from the scope of the invention. The invention may also be said broadly to consist in the parts, elements and features referred to or indicated in the specification of the application, individually or collectively, in any or all combinations of two or more of said parts, elements or features. Furthermore, where reference has been made to specific components or integers of the invention having known equivalents, then such equivalents are herein incorporated as if individually set forth.

Any discussion of the prior art throughout the specification should in no way be considered as an admission that such prior art is widely known or forms part of common general knowledge in the field.

1. A method comprising switching a multilevel converter to produce a repeating AC waveform across a compensation network of a resonant inductive power transfer primary, wherein the multilevel converter comprises a plurality of submodules each having at least two switches, and the method comprises complementarily switching the at least two switches of each of the plurality of submodules to substantially coincide with zero crossings in the repeating AC waveform.

2. The method of claim 3, wherein the method comprises alternating submodules from a first limb of the converter with submodules from a second limb of the converter to produce a symmetric bipolar square voltage waveform across the compensation network.

3. The method of claim 2, wherein the method comprises controlling, for each half cycle of the square voltage waveform, the number of submodules from the first limb of the converter that are switched into a circuit with the compensation network, relative to the number of submodules, from the second limb of the converter, that are switched into the circuit with the compensation network, to regulate the power transferred to an inductive power transfer secondary.

4. The method of claim 1, wherein the method comprises limiting the maximum switching frequency of the at least two switches of each of the plurality of submodules to a frequency that is no greater than the resonant frequency of the compensation network.

5. The method of claim 4, wherein the method comprises selecting a square voltage waveform, from a finite number of square voltage waveforms, to control the power made available for inductive power transfer, wherein each of the finite number of square voltage waveforms has a discrete amplitude, and the method comprises selectively inserting the plurality of submodules into a circuit with the compensation network to produce the selected square voltage waveform across the compensation network.

6. The method of claim 4, wherein the method comprises staggering the gate signals for the at least two switches of each of the plurality of submodules to introduce a dead time where neither switch is conducting when the switches complementarily change state.

7. A method comprising driving a resonant inductive power transfer primary at discrete power levels by operating a multilevel converter at a resonant frequency of the resonant inductive power transfer primary, wherein the multilevel converter comprises a plurality of submodules and each of the plurality of submodules has at least two switches, and the method comprises switching the submodules of the converter with a duty cycle selected from the group of duty cycles consisting of: 0%, 50% and 100%.

8. The method of claim 7, wherein the method comprises concurrently switching: a first submodule from the plurality of submodules with a duty of 0%; a second submodule from the plurality of submodules with a duty of 50%; and a third submodule from the plurality of submodules with a duty of 100%.

9. The method of claim 7, wherein the method comprises concurrently switching all of the submodules of the multilevel converter with a duty cycle that is selected from the group of duty cycles consisting of: 50% and 100%.

10. The method of claim 7, wherein the method comprises not hard switching the at least two switches of each of the plurality of submodules at turn-on.

11. The method of claim 7, wherein the method comprises operating the multilevel converter to produce a finite number of voltage waveforms each having a discrete time invariant magnitude.

12. The method of claim 11, wherein the finite number of voltage waveforms is less than or equal to 30 waveforms with different amplitude.

13. The method of claim 7, wherein the method comprises operating the multilevel converter to produce a repeating voltage waveform at the resonant frequency of the resonant inductive power transfer primary, and switching a subset of the plurality of submodules with a duty cycle of 100% for multiple consecutive cycles of the repeating voltage waveform.

14. A method comprising switching a multilevel inverter to cause inductive power transfer from a resonant inductive power transfer primary, wherein the multilevel inverter comprises a plurality of submodules, and the method comprises switching each of the plurality of submodules, with zero voltage turn-on, to selectively insert each of the plurality of submodules into a circuit with a compensation network of the resonant inductive power transfer primary.

15. The method of claim 14, wherein the method comprises producing a square voltage waveform between a first subset of the plurality of submodules and a second subset of the plurality of submodules, and regulating an amplitude of the square voltage waveform to control power transfer from the resonant inductive power transfer primary.

16. The method of claim 15, wherein the method comprises selecting an amplitude for the square voltage waveform, from a finite number of discrete amplitudes, and controlling the number of submodules in the first subset of the plurality of submodules that are inserted into the circuit with the compensation network relative to the number of submodules in the second subset of the plurality of submodules that are inserted into the circuit with the compensation network to achieve the selected amplitude for the square voltage waveform.

17. The method of claim 15, wherein the method comprises switching all of the submodules from the second subset of the plurality of submodules out of the circuit with the compensation network for a half cycle of the square voltage waveform, and switching at least one submodule from the first subset of the plurality of submodules into the circuit with the compensation network for the half cycle of the square voltage waveform.

18. The method of claim 15, wherein the method comprises:
switching at least one submodule, from the first subset of the plurality of submodules, into the circuit with the compensation network, and concurrently switching at least one submodule, from the second subset of the plurality of submodules, out of the circuit with the compensation network, to create a first half cycle of the square voltage waveform; and
switching at least one submodule, from the second subset of the plurality of submodules, into the circuit with the compensation network, and concurrently switching at least one submodule, from the first subset of the plurality of submodules, out of the circuit with the compensation network to create a second half cycle of the square voltage waveform.

19. The method of claim 14, wherein the method comprises switching each of the plurality of submodules with a switching frequency that is no higher than the resonant frequency of the compensation network.

20. The method of claim 14, wherein the method comprises a step for soft-switching at least two switches from each of the plurality of submodules to produce a repeating AC waveform across the compensation network of the resonant inductive power transfer primary.

21.-40. (canceled)
